(19) United States
(12) Patent Application Publication
(10) Pub. No.: US 2008/0288494 A1
(43) Pub. Date: Nov. 20, 2008

(54) System Enabling Social Networking Through User-Generated Lists

(75) Inventors: Greg Brogger, Santa Monica, CA (US); Gavin Purcell, Los Angeles, CA (US); Jim Berger, Los Angeles, CA (US)

Correspondence Address: AKA CHAN LLP, 900 LAFAYETTE STREET, SUITE 710, SANTA CLARA, CA, 95050, US

(73) Assignee: ListSpinner Inc., Santa Monica, CA (US)

(21) Appl. No.: 12/116,758

(22) Filed: May 7, 2008

Related U.S. Application Data
(60) Provisional application No. 60/916,368, filed on May 7, 2007.
(60) Provisional application No. 61/023,791, filed on Jan. 25, 2008.

(51) Int. Cl. G06F 17/30; G06F 3/048

(52) U.S. Cl. 707/7; 715/810; 707/E17.001

(57) ABSTRACT

A group of users is connected through a network such as the Internet to a system that both creates lists in an automated fashion by searching the Internet and compiling relevant data and also enables users to create and maintain lists, share lists with other users, and search for lists and information related to lists. In an implementation, the system will generate a list database based on the lists created or populated by users of the system. The list database may also include previously built lists or lists of publications, organizations, or groups.

### CROSS-REFERENCE TO RELATED APPLICATIONS

This application claims the benefit of U.S. provisional patent applications 60/916,368, filed, May 7, 2007, and 61/023,791, filed Jan. 25, 2008, which are incorporated by reference along with all other references cited in this application.

### BACKGROUND OF THE INVENTION

This invention relates to the field of information management and more specifically, to a system of organizing and disseminating information through a network such as the Internet.

Computer and data networks enable computer users (and users of other electronic devices) to connect and communicate with each other more easily. There are many types of computer networks and networking technologies including the wired, wireless, Ethernet, local area networks, intranet, and the Internet. The widespread success of computer networks has enabled the creation numerous applications for users to communicate or otherwise network with other users.

There are many examples of very successful applications using computer networks including e-mail, instant messenger, and the Web browser for surfing the World Wide Web. In addition to business use, computer networks also are often used for entertainment and social networking. For example, people use their computers and the Internet to find others with similar interests or hobbies, entertainment, matchmaking and meeting new people, sharing photos and videos, announcing and organizing parties, and playing massively multiplayer on-line role-playing games.

Despite the success of Internet, there is a continual need for additional and improved techniques and systems for organizing and disseminating information for users and connecting users to one another.

### BRIEF SUMMARY OF THE INVENTION

A group of users is connected through a network such as the Internet to a system that both creates lists in an automated fashion by searching the Internet and compiling relevant data and also enables users to create and maintain lists, share lists with other users, and search for lists and information related to lists. In an implementation, the system will generate a list database based on the lists created or populated by users of the system. The list database may also include previously built lists or lists of publications, organizations, or groups.

“Lists” for these purposes includes two or more items that are related to a single topic and displayed as such. Those list items may be composed of text, audio, or video content, or any combination of these. The topic or organizing principle of a list can be a ranking by preference or quality (e.g., “best of” or “worst of”), an unranked but related list of items falling into the same category, a music playlist, or a variety of other types.

Users can publish their lists on the system, to blogs, other social networking sites such as MySpace, Facebook, Friendster, LinkedIn, Ryze, YouTube, Windows Live Spaces, tribe.net, Flickr, or any other Web site, or e-mail the lists to others. Other users can then comment on the list and share their own knowledge and opinions. Users can search and explore lists created by others.

The system also provides for contextual advertising in which the advertising relates to the subject matter of the list. For example, if the user is viewing a list of music groups then an advertisement for the groups' music may appear on the screen.

In an embodiment, the invention is a method that includes receiving a first list of items from a first user, where the first list includes at least a first item, receiving a second list of items from a second user, where the second list includes the at least first item, determining an order for a third list of items where the third list includes the at least first item and the determination includes performing a mathematical computation involving a first value and a second value. The first value corresponds to a first position of the first item in the first list and the second value corresponds to a second position of the first item in the second list. The method further includes displaying on a computer screen the third list of items in the order.

The first list and second list may further include at least a second item. The mathematical computation may further involve a third value and a fourth value. The third value corresponds to a third position of the second item in the first list and the fourth value corresponds to a fourth position of the second item in the second list.

The method may further include when displaying on a computer screen the third list of items in the order, if the first value added to the second value is greater than the third value added to the fourth value, displaying the first item above the second item.

The method may further include when displaying the third list of items on a computer screen in the order, if the first value added to the second value is less than the third value added to the fourth value, displaying the first item below the second item.

In an embodiment, the method may further include displaying on the computer screen a user-selectable object associated with the first list. When the second user selects the user-selectable object, displaying on the computer screen for the second user the first list of items from the first user. The user-selectable object may be a hyperlink which includes a username of the first user. The at least first item may include a multimedia file stored on a central server.

In another embodiment, the invention is a method including displaying a first plurality of items from a list in a main item section on an electronic screen, where an item includes a first user-selectable button, a number, and an item name, displaying a second plurality of items from the list in an item scroll box having a scroll bar. When a first user selects the first user-selectable button using a pointing device, displaying an edit item window, where the edit item window includes an item title input box. As a user drags the scroll bar, displaying additional items from the list in the item scroll box without closing the edit item window.

The first plurality of items from the list may include a subset of items from the list and the item scroll box may include a complete set of items from the list.

When the first user selects a first item name from the item scroll box using the pointing device, the method further includes displaying the first item name in the item title input box of the edit item window.

The edit item window may include a second user-selectable button. When the first user selects the second user-selectable button, the method further includes closing the edit item window and displaying the first item name from the item scroll box in the main item section.

The edit item window may include an item universal resource locator input box. The item name may be a hyperlink. After the first user clicks on the hyperlink, the method further includes playing a multimedia file on a first user's client device, where the multimedia file is stored on a centrally located server. The first plurality of items may be an ordered list.

The ordered list may include a first item, a second item, and a third item. In an embodiment, the first item is displayed above the second item and the third item, and the second item is displayed above the third item. When the user drags the first item to a position between the second item and the third item, the method includes displaying the second item above the first item and the third item, and the first item above the third item.

The method further includes receiving a command from the first user to save the list after displaying the first item name from the item scroll box in the main item section and after receiving the command, sending an e-mail notification to a second user.

The e-mail notification may include a link to the list.

The method may further include displaying an item title where the item title is noneditable by the first user.

Other objects, features, and advantages of the present invention will become apparent upon consideration of the following detailed description and the accompanying drawings, in which like reference designations represent like features throughout the figures.

### BRIEF DESCRIPTION OF THE DRAWINGS

FIG. 1 shows a simplified block diagram of a client-server system and network in which an embodiment of the invention may be implemented.

FIG. 2 shows a more detailed diagram of a client or computer which may be used in an implementation of the invention.

FIG. 3 shows a system block diagram of a computer system used to execute application programs such as a Web browser or as a server in an implementation of the invention.

FIG. 4 shows a flow of a first implementation of the invention through Web site screens.

FIG. 5 shows a first implementation of a home page screen for a list making tool and list searching tool.

FIG. 6 shows a share list page.

FIG. 7 shows an invitee page.

FIG. 8 shows a list status page.

FIG. 9 shows a search list titles result page.

FIG. 10 shows a search list originators and groups page.

FIG. 11 shows a category list page.

FIG. 12 shows a flow of a second implementation of the invention through Web site screens.

FIG. 13 shows a first implementation of a login page for a list making tool and list searching tool.

FIG. 14 shows a second implementation of a login page.

FIG. 15 shows a third implementation of a login page.

FIG. 16 shows a second implementation of a home page.

FIG. 17 shows a create a list page.

FIG. 18 shows an edit a list page.

FIG. 19 shows an edit a list item page.

FIG. 20 shows a search lists results page.

FIG. 21 shows a tag cloud results page.

FIG. 22 shows a user profile page.

### DETAILED DESCRIPTION OF THE INVENTION

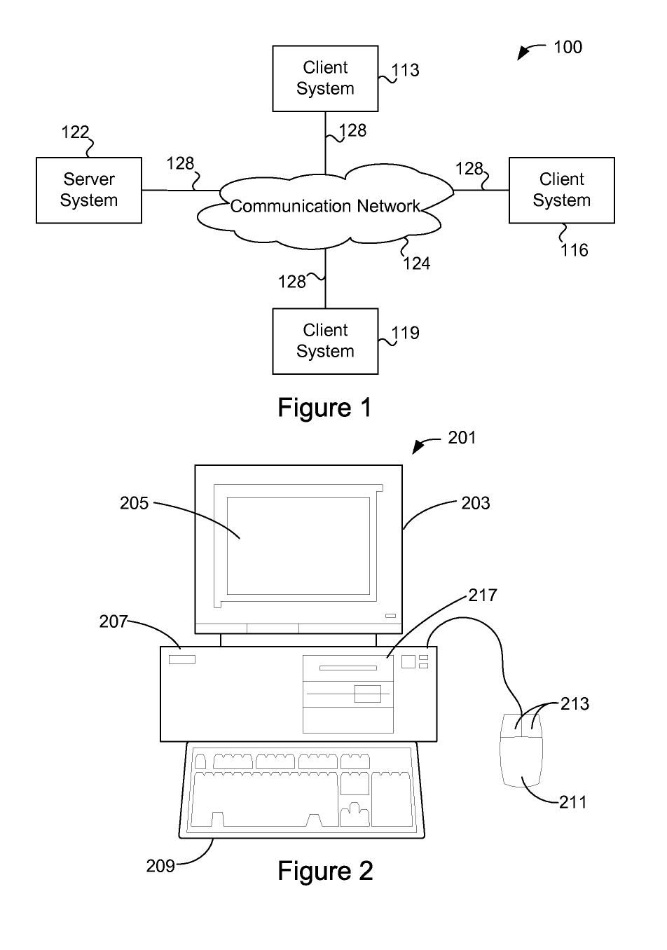

FIG. 1 shows a simplified block diagram of a distributed computer network 100 in which an embodiment of the present invention may be implemented. Computer network 100 includes a number of client systems 113, 116, and 119, and a server system 122 coupled to a communication network 124 via a plurality of communication links 128. Communication network 124 provides a mechanism for allowing the various components of distributed network 100 to communicate and exchange information with each other.

Communication network 124 may itself be comprised of many interconnected computer systems and communication links. Communication links 128 may be hardwire links, optical links, satellite or other wireless communications links, wave propagation links, or any other mechanisms for communication of information. Various communication protocols may be used to facilitate communication between the various systems shown in FIG. 1. These communication protocols may include TCP/IP, HTTP protocols, wireless application protocol (WAP), vendor-specific protocols, customized protocols, and others. While in one embodiment, communication network 124 is the Internet, in other embodiments, communication network 124 may be any suitable communication network including a local area network (LAN), a wide area network (WAN), a wireless network, an intranet, a private network, a public network, and a switched network, and combinations of these, and the like.

Distributed computer network 100 in FIG. 1 is merely illustrative of an embodiment incorporating the present invention and does not limit the scope of the invention as recited in the claims. One of ordinary skill in the art would recognize other variations, modifications, and alternatives. For example, more than one server system 122 may be connected to communication network 124. As another example, a number of client systems 113, 116, and 119 may be coupled to communication network 124 via an access provider (not shown) or via some other server system.

Client systems 113, 116, and 119 typically request information from a server system which provides the information. For this reason, server systems typically have more computing and storage capacity than client systems. However, a particular computer system may act as both as a client or a server depending on whether the computer system is requesting or providing information. Additionally, although aspects of the invention has been described using a client-server environment, it should be apparent that the invention may also be embodied in a stand-alone computer system.

Server 122 is responsible for receiving information requests from client systems 113, 116, and 119, performing processing required to satisfy the requests, and for forwarding the results corresponding to the requests back to the requesting client system. The processing required to satisfy the request may be performed by server system 122 or may alternatively be delegated to other servers connected to communication network 124.

In an embodiment of the present invention, client systems 113, 116, and 119 enable users to access and query information stored by server system 122. In a specific embodiment, a “Web browser” application executing on a client system enables users to select, access, retrieve, or query information stored by server system 122. Examples of Web browsers include the Internet Explorer browser program by Microsoft Corporation and the Firefox browser by Mozilla.

FIG. 2 shows an example of a client system of the present invention. Although they system in FIG. 2 is discussed in connection with a client-side of the invention, this system may also be used as a server in implementing a server-side of the invention; multiple servers may be used in a specific implementation. In an embodiment, a user interfaces with the system through a computer workstation system, such as shown in FIG. 2. FIG. 2 shows a computer system 201 that includes a monitor 203, screen 205, cabinet 207, keyboard 209, and mouse 211. Mouse 211 may have one or more buttons such as mouse buttons 213. Cabinet 207 houses familiar computer components, some of which are not shown, such as a processor, memory, mass storage devices 217, and the like.

Mass storage devices 217 may include mass disk drives, floppy disks, magnetic disks, optical disks, magneto-optical disks, fixed disks, hard disks, CD-ROMs, recordable CDs, DVDs, recordable DVDs (e.g., DVD-R, DVD+R, DVD-RW, DVD+RW, HD-DVD, or Blu-ray Disc), flash and other nonvolatile solid-state storage (e.g., USB flash drive), battery-backed-up volatile memory, tape storage, reader, and other similar media, and combinations of these.

A computer-implemented or computer-executable version of the invention may be embodied using, stored on, or associated with computer-readable medium. A computer-readable medium may include any medium that participates in providing instructions to one or more processors for execution. Such a medium may take many forms including, but not limited to, nonvolatile, volatile, and transmission media. Nonvolatile media includes, for example, flash memory, or optical or magnetic disks. Volatile media includes static or dynamic memory, such as cache memory or RAM. Transmission media includes coaxial cables, copper wire, fiber optic lines, and wires arranged in a bus. Transmission media can also take the form of electromagnetic, radio frequency, acoustic, or light waves, such as those generated during radio wave and infrared data communications.

For example, a binary, machine-executable version, of the software of the present invention may be stored or reside in RAM or cache memory, or on mass storage device 217. The source code of the software of the present invention may also be stored or reside on mass storage device 217 (e.g., hard disk, magnetic disk, tape, or CD-ROM). As a further example, code of the invention may be transmitted via wires, radio waves, or through a network such as the Internet.

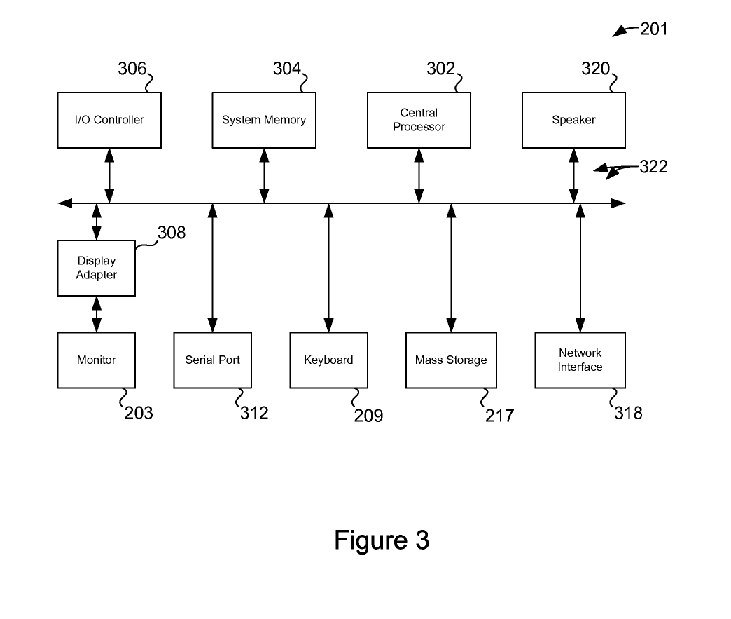

FIG. 3 shows a system block diagram of computer system 201 used to execute the software (either client side or server side) of the present invention. As in FIG. 2, computer system 201 includes monitor 203, keyboard 209, and mass storage devices 217. Computer system 501 further includes subsystems such as central processor 302, system memory 304, input/output (I/O) controller 306, display adapter 308, serial or universal serial bus (USB) port 312, network interface 318, and speaker 320. The invention may also be used with computer systems with additional or fewer subsystems. For example, a computer system could include more than one processor 302 (i.e., a multiprocessor system) or a system may include a cache memory.

Arrows such as 322 represent the system bus architecture of computer system 201. However, these arrows are illustrative of any interconnection scheme serving to link the subsystems. For example, speaker 320 could be connected to the other subsystems through a port or have an internal direct connection to central processor 302. The processor may include multiple processors or a multicore processor, which may permit parallel processing of information. Computer system 201 shown in FIG. 2 is but an example of a computer system suitable for use with the present invention. Other configurations of subsystems suitable for use with the present invention will be readily apparent to one of ordinary skill in the art.

Computer software products may be written in any of various suitable programming languages, such as C, C++, C#, Pascal, Fortran, Perl, Matlab (from MathWorks, www.mathworks.com), SAS, SPSS, JavaScript, AJAX, and Java. The computer software product may be an independent application with data input and data display modules. Alternatively, the computer software products may be classes that may be instantiated as distributed objects. The computer software products may also be component software such as Java Beans (from Sun Microsystems) or Enterprise Java Beans (EJB from Sun Microsystems).

An operating system for the system may be one of the Microsoft Windows® family of operating systems (e.g., Windows 95, 98, Me, Windows NT, Windows 2000, Windows XP, Windows XP x64 Edition, Windows Vista, Windows CE, Windows Mobile), Linux, HP-UX, UNIX, Sun OS, Solaris, Mac OS X, Alpha OS, AIX, IRIX32, or IRIX64. Other operating systems may be used. Microsoft Windows is a trademark of Microsoft Corporation.

Furthermore, the computer may be connected to a network and may interface to other computers using this network. The network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11 g, 802.11i, and 802.11n, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download Web pages or other content in various formats including HTML, XML, text, PDF, and PostScript, and may be used to upload information to other parts of the system. The Web browser may use uniform resource identifiers (URLs) to identify resources on the Web and hypertext transfer protocol (HTTP) in transferring files on the Web.

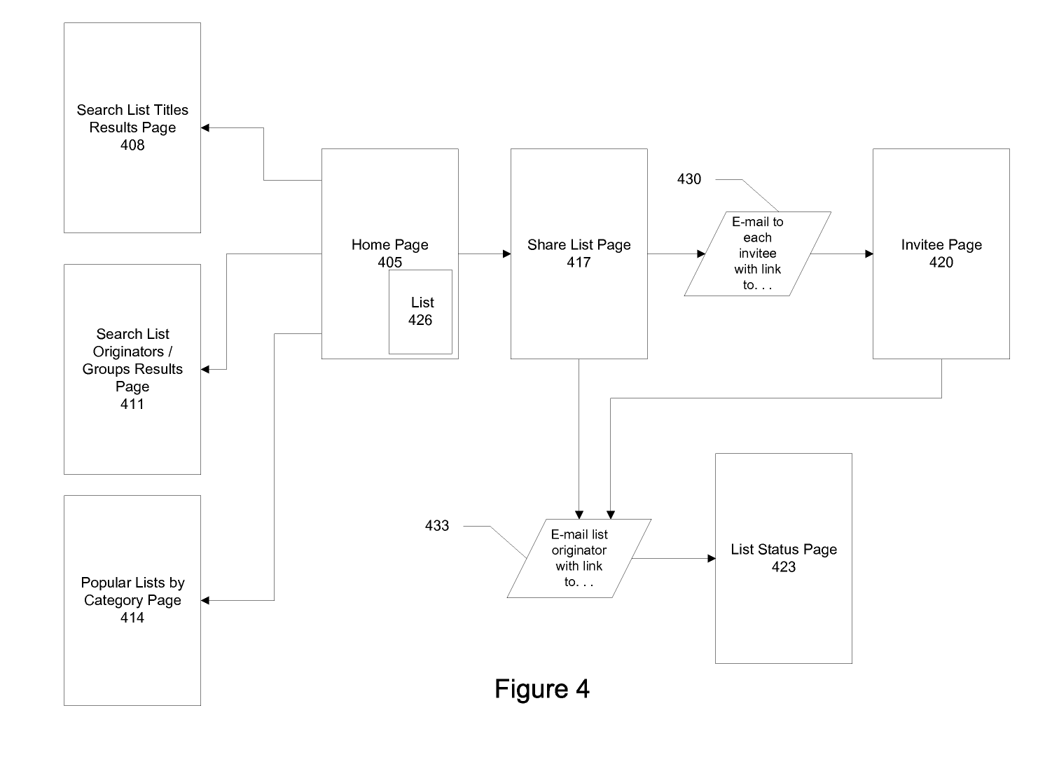

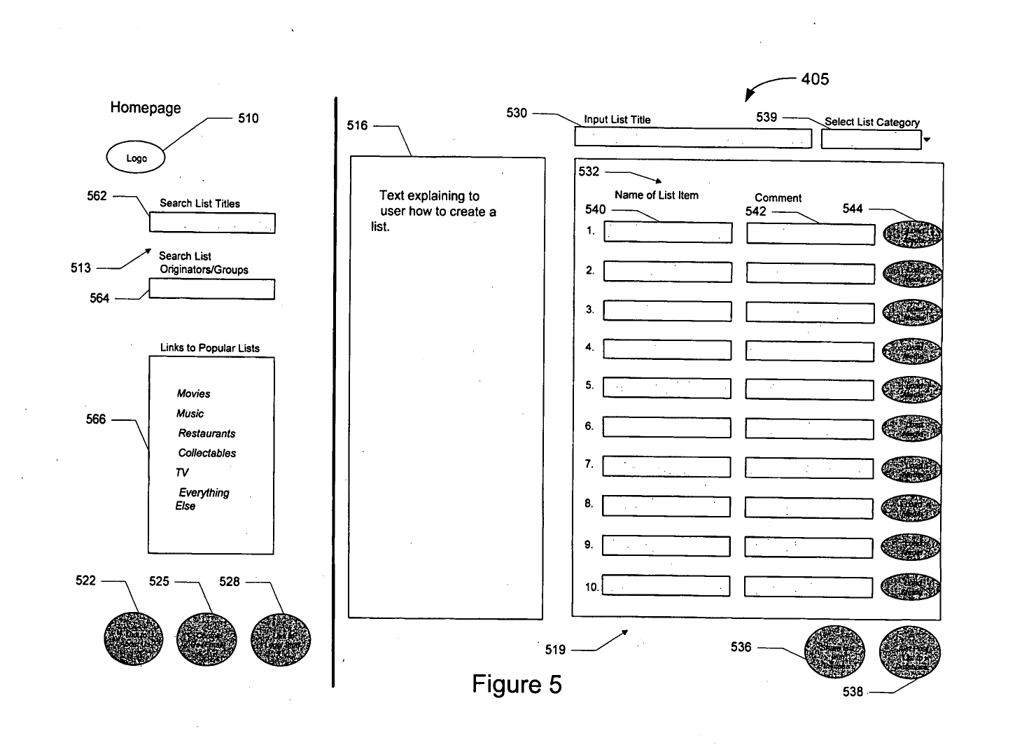

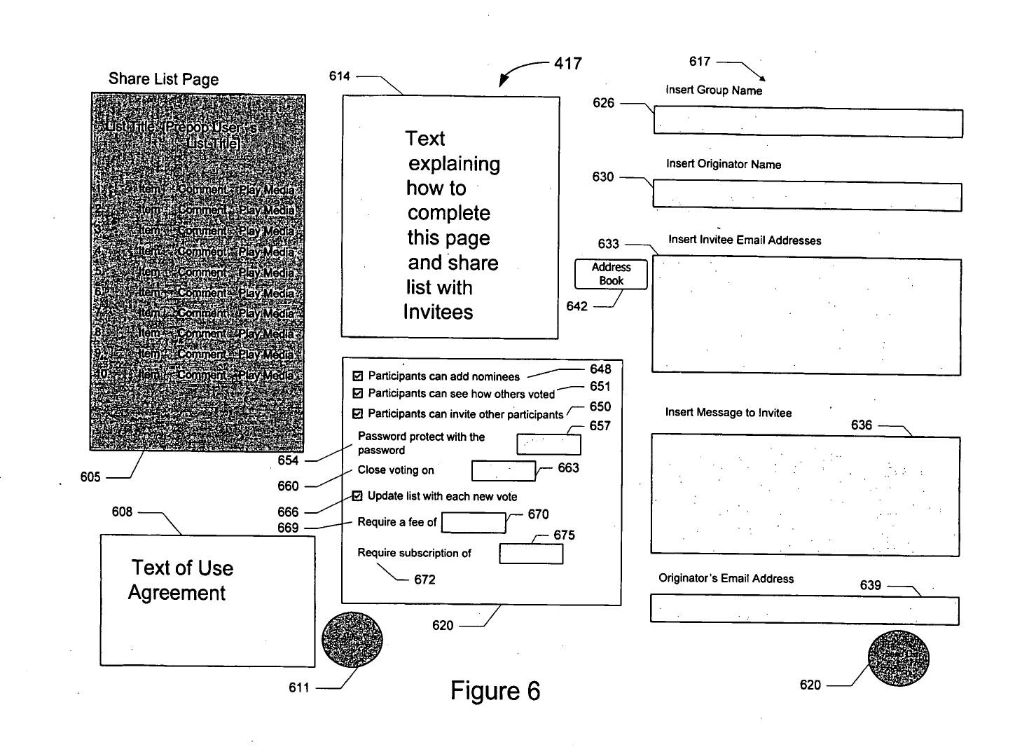

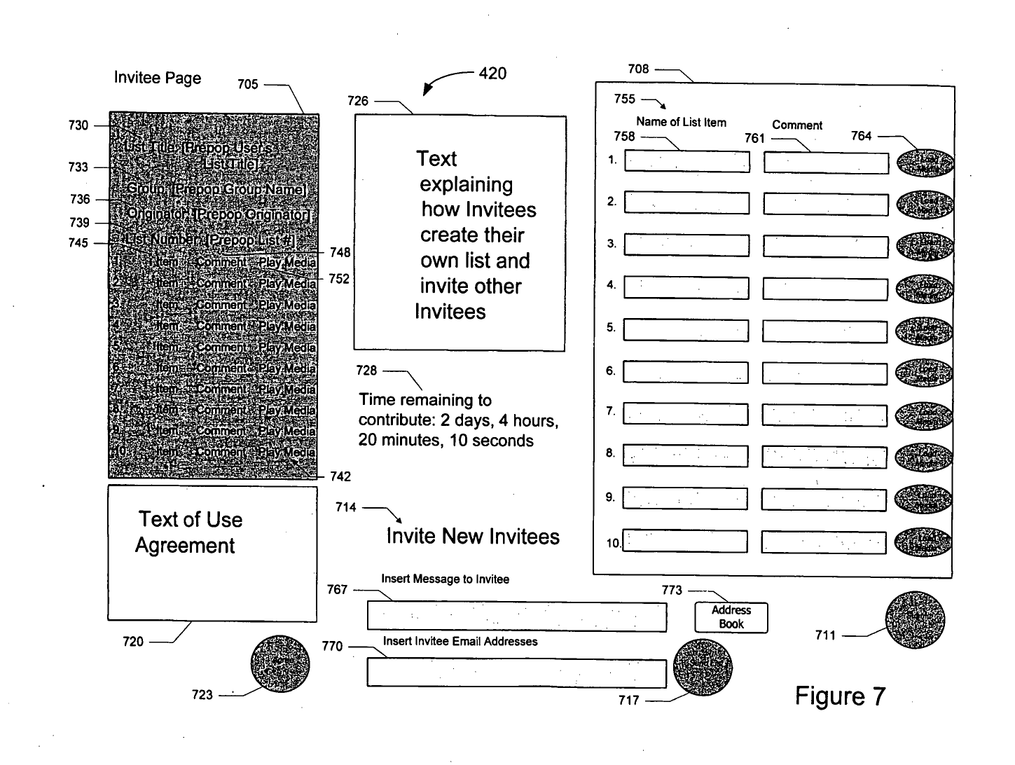

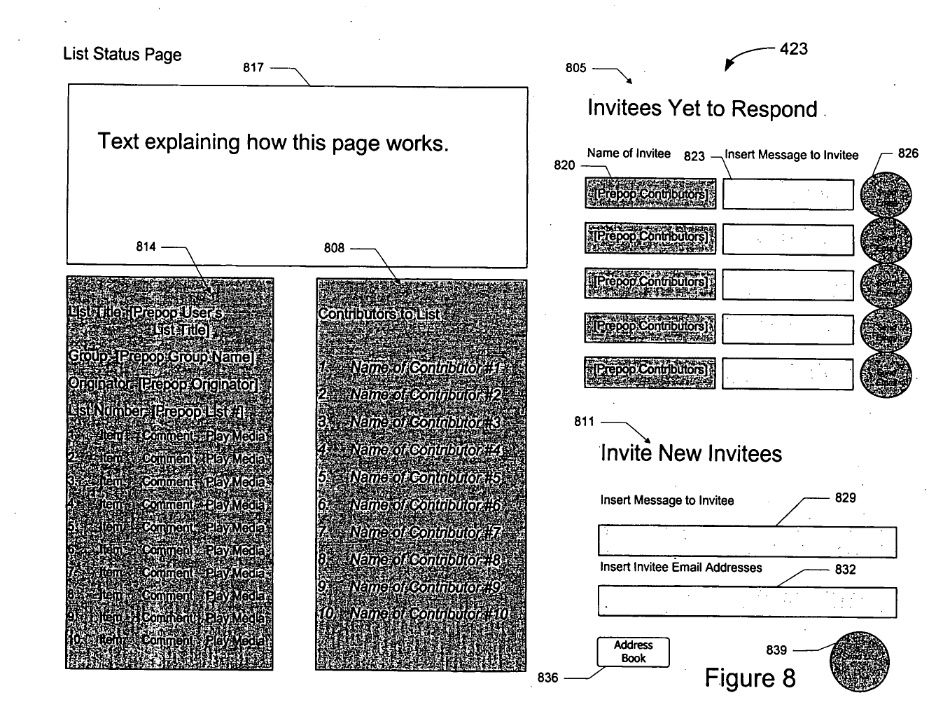

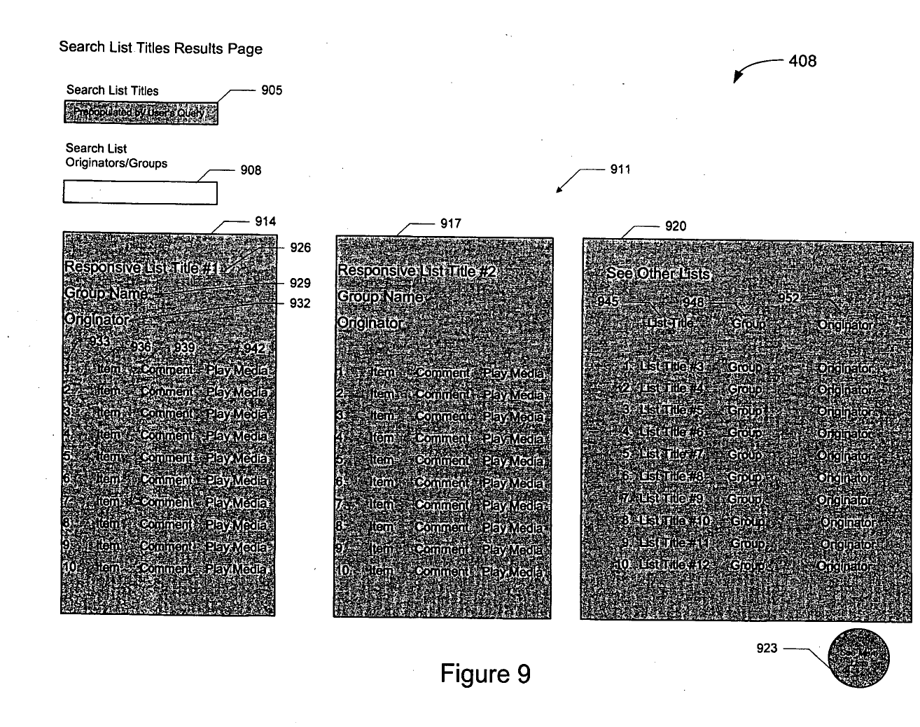

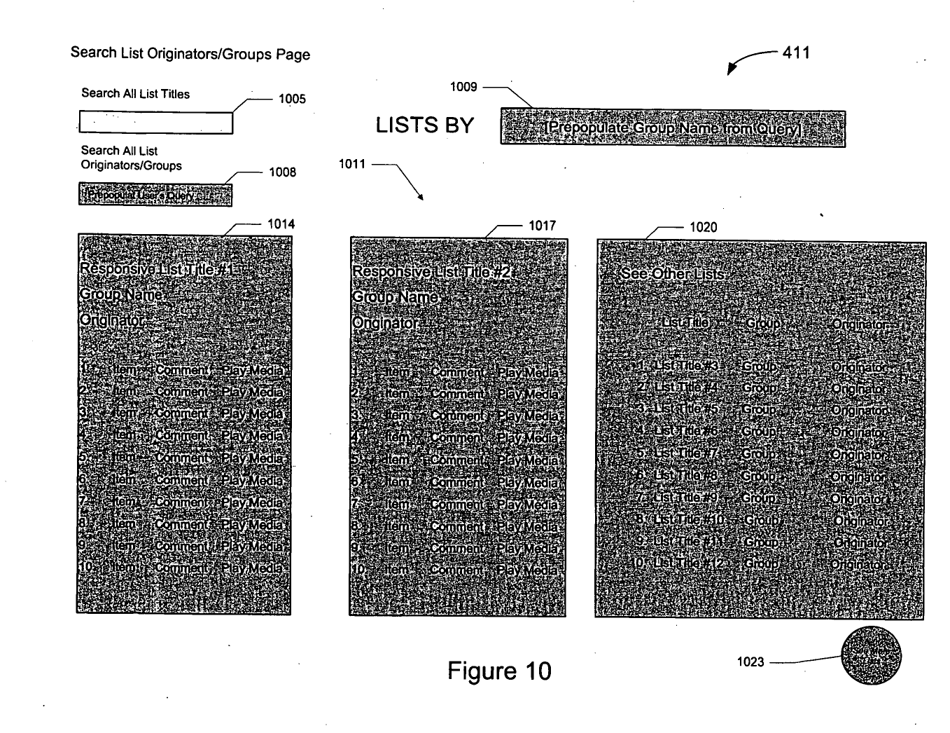

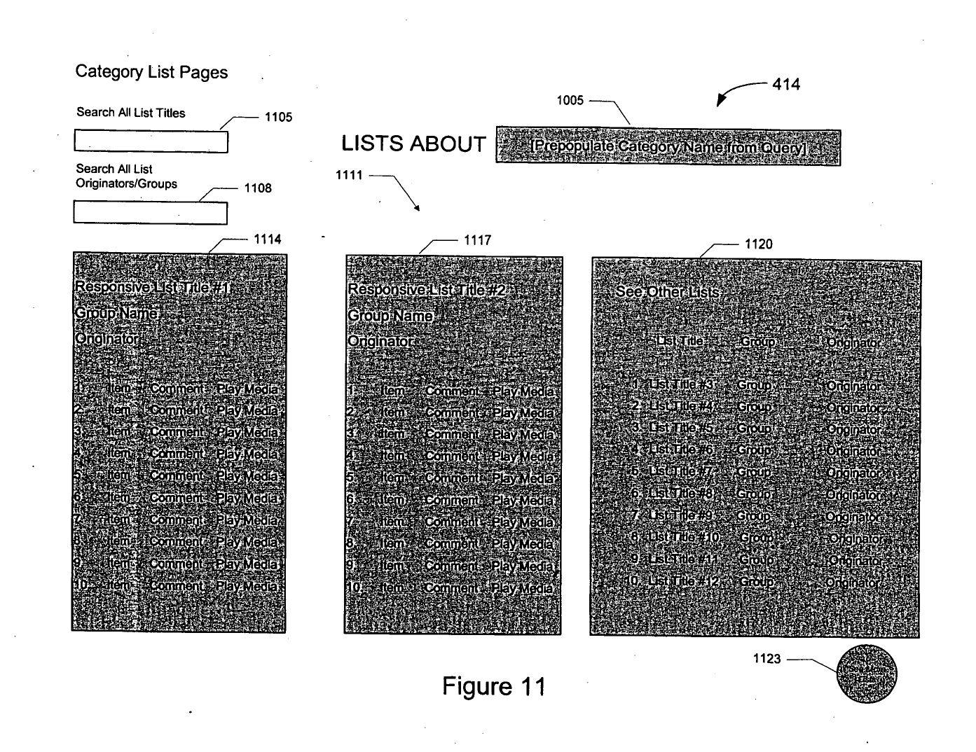

FIG. 4 shows a flow of a first implementation of the invention through Web site screens. The figure shows Web screens and arrows indicating flow from one screen to another. Page 405 is a home page and a detailed view is provided in FIG. 5. Page 408 is a search list titles results page and a detailed view is provided in FIG. 9. Page 411 is a search list originators and groups page and a detailed view is provided in FIG. 10. Page 414 is a popular list by category page and a detailed view is provided in FIG. 11. Page 417 is a share list page and a detailed view is provided in FIG. 6. Page 420 is an invitee page and a detailed view is provided in FIG. 7. Page 423 is a list status page and a detailed view is provided in FIG. 8.

In a specific embodiment, the invention is a list making tool or system available to users through the Internet. This software tool will store all of the data generated by the lists, list originators, list participants, and other data related to the list on a database. The database will then be searchable by the public via a word search interface accessed through a home page screen.

Home page 405 includes a list region 426. In a specific embodiment of the invention, “lists” refer to two or more items that are related to a single topic and displayed as such. Those list items may be composed of text, audio, or video content, or any combination of these. The topic or organizing principle of a list can be a ranking by preference or quality (e.g., “best of” or “worst of”), an unranked but related list of items falling into the same category, a music playlist, or a variety of other types.

The list making tool will be an easy, fun way for users to create top-ten-type lists, music playlists, and other types of lists to be shared with a community interested in the list. For example, a film enthusiast might want to create a list of the top ten gangster films of all time and get the input of his circle of friends. The tool would allow him to quickly define the category, put together a list of nominees, create his own ranking from among them and then, distribute the list to his intended participants via share list page 417. The share list page allows the list originator to specify one or more invitees to his list.

In a step 430, the tool then generates an e-mail to each of the invitees. The e-mail includes a link to invitee page 420. The invitee page allows each of the invited recipients to review the list originator's list and rank order it according to their preference—effectively “voting” for their own favorites—and enter their commentary to their submission (effectively creating a blog specific to the list). The Web site would host a page dedicated to the list; the Web page would be accessible through the links in the list maker's e-mails to the list maker's invitees. A list can also be displayed as an insert to a blog or framed into any third party's Web page. As each participant gives his input to the list, the list is updated to show who voted, for which films and what is the aggregated group's ranking. The list's Web page generates outbound e-mails to the list participants to keep them updated on the list's activity.

In a step 433, the tool generates a confirmation or notification e-mail to the list originator when the list is shared by the list originator, edited by an invitee, or both. The e-mail includes a link to list status page 423. The list status page allows, for example, the list originator to see which invitees have contributed to the list, add new invitees, and see which invitees have yet to respond.

System also allows provides various ways for users to search and browse through the various lists stored in the system. For example, from the home page, the user can search by the list titles (e.g., best gangster movies, spiciest That dishes, funniest jokes, and most secluded beaches). The results are then shown on search list titles results page 408. The user can also search by the list originator. The list originator may be an individual, group, or both. The results are then shown on search list originators/groups results page 411. As another example, the user can also browse various lists by categories (e.g., movies, music, restaurants, collectables, television shows, and miscellaneous) via popular lists by category page 414.

FIG. 5 shows a detailed view of an example of home page 405. The home page includes a brand region 510, search tools 513, a help region 516, and a list creation region 519.

The home page may also include links related to the company that is hosting the system. This includes, for example, an “about us” link 522, a “contact us” link 525, and a “legal stuff” link 528.

The list creation region is where the user creates a list. The list creation region includes a title input box 530, one or more numbered item entries 532, a share list with invitees button 536, and a just post list to database button 538. A specific implementation may also include a drop down category box 539.

The user enters the title of their list in the title input box (e.g., top ten horror movies of 2008, best restaurants in New York City, best surfing beaches in California, and funniest celebrity quotes).

The user selects a category for their list using the drop down category box. In a specific implementation, this category box is prepopulated with categories for the user to choose. An example of categories includes movies, music, restaurants, collectables, television, and everything else. This allows, for example, other users to be able to perform category searches based on this field.

There may be any number of item entries. Typically, there are ten item entries. However, because the number of entries are determined by the user, the number of entries may range from one to more than ten item entries. A specific implementation may include a button, i.e., an add item button, that when clicked adds additional blank item entries for the user. An item entry may include an item name box 540, an item comment box 542, and a load media button 544.

For each item entry, the user may enter the name of the item in the item name box, a comment, and upload a file associated with the item entry. In a specific implementation, the file is stored on a centrally located server. Entering a comment and uploading a file are optional steps and the user may decide to just enter the name of the item. The item can be plain text (e.g., just the movie titles), links to third party content (e.g., images, Web pages, blogs, audio, and so forth).

Any type of file (e.g. text, graphics, slideshows, audio, video, and multimedia) may be uploaded to the system. Some examples of audio file formats include Waveform (wav), OGG, Musepack (mpc), Free Lossless Audio Codec (flac), Audio Interchange File Format (aiff), au, Global System for Mobile Communications (gsm), dct, Dialogic Adaptive Differential Pulse Code Modulation (vox), Advanced Audio Coding Format (aac), Moving Picture Experts Group (mpeg, mpeg2, mpeg3, mpeg4), Windows Media Audio (wma), Adaptive Transform Acoustic Coding (atrac), Real Audio (ra), Digital Speech Standard (dss), Memory Stick Voice file (msv), Digital Voice File (dvf), iKlax, Sound Designer I (SDI), and Sound Designer II (SDII).

Some examples of video file formats include Audio Video Interleave (avi), Windows Media (wmv), Moving Pictures Expert Group (mpg or mpeg), QuickTime (mov), RealVideo (rm or ram), and Flash (swf).

Some examples of graphics file formats include Graphics Interchange (gif), Joint Photographic Experts Group (jpeg), Bitmap (bmp), Tag Interchange File (tif), and Portable Network Graphics (png).

In a specific implementation, the position of the item in the list is an indication of the item's rank. For example, an item in the first row indicates that the user prefers that item over another item that is in the second row. The user may reorder the list in any number of ways. For example, the user may highlight or select a list item and drag the item to a different position. As another example, each item may include an up arrow and a down arrow. Clicking the up arrow moves the item one step higher in the list, while clicking the down arrow moves the item one step lower in the list.

Brand region 510 includes, for example, the company's logo, name, or both. In a specific implementation the system may be customized for use by a specific company to create a community around its own content. The company may utilize an embodiment of the system to display its own logo, layout, preferred colors, and content. The company may restrict the usable list content only to those items authorized and added to the system by the company. This may be implemented in any number of ways. For example, in a specific implementation, the user can only create and edit lists by selecting list items from a company approved list of items.

As an example, Disney may utilize a version of the system to display the Disney logo and colors. Furthermore, Disney may restrict the list content to only include Disney children movies. One benefit to this feature is that parents can let their children participate in list making and sharing. The parents will not have to worry about the Web site containing lists that may be inappropriate for children such as lists concerning smut, pornography, or violence (e.g., top ten horror movies, top ten “hottest” adult movie actors, and most offensive quotes of 2008).

Search tools region 513 may include any number of tools to help the user search and browse through the various lists on the system. A search list titles tool 562 allows the user to search by list title. A search list originators/groups tool 564 allows the user to search by list originator. The list originator may be an individual, group, or both. The search list titles and search list originators/groups tool may perform searches by key words.

A popular list tool 566 may include one or more user-selectable categories of popular lists such as movies, music, restaurants, collectables, television, and miscellaneous. Clicking on a category takes the user to a page which displays popular lists for that category. The system may determine the popularity of a list and thus whether that list is displayed within the selected category using any number of algorithms. In a specific implementation, the system tallies for each list in a selected category the number of users who voted on items (i.e., nominees) in the list. A first list that receives more votes than a second list indicates that the first list is more popular than the second list.

FIG. 6 shows an example of share list page 417. The share list page includes an originator's list 605, a text region 608 for explaining the terms of use, a button 611 to indicate agreement with the terms of use, a text region 614 for instructions, an invitee information region 617, a list rules region 620, and a send list button 623

The invitee information region includes a group name input box 626, an originator name input box 630, an invitee e-mail address input box 633, a message to invitee input box 636, and an originator's e-mail address input box 639.

The group name input box allows the originator to enter a group name. Most lists will specify a “Group” which will identify how the invitees are associated with one another (e.g., members of a club, blog, or other identifying principle). The list making tool will automatically generate and host a separate Web page for each such Group. The page will display all (and only) the lists generated by that Group. So for example, when the first list is created for the Peachhead Group, a page displaying all of the Peachhead Lists gets generated. The page is then accessible through links embedded in any of the outbound e-mails to members of the Group and in links embedded in each the Peachhead Lists.

The originator name input box and originator's e-mail address input box is for the originator to enter their name and e-mail address, respectively. In a specific implementation, this information is automatically populated. For example, the system may require that the originator first register and log into the system. Registration information may include the originator's name and e-mail address which is stored in a central database in a user profile. The system may then automatically populate the originator name input box and originator's e-mail address input box with information from the user profile. In another implementation, this information is not automatically populated and the user must manually enter the information.

The invitee e-mail address input box allows the originator to enter in the e-mail addresses for one or more invitees. The e-mail addresses may be separated by a comma, semi-colon, return, or combinations of these. In a specific implementation, an address book button 642 is provided. Clicking on the address book button opens an address book window. The address book window includes a list of contacts and a checkbox next to each contact. The user can scroll through the list of contacts and using the checkbox select which contacts to invite to the list. The system then automatically adds the e-mail address for the checked contacts to the invitee e-mail address input box. One benefit of this feature is that it saves the originator the step of having to always manually enter in the e-mail addresses of users he wants to invite.

The message to invitee box allows the originator to enter a message to the invitees. The message may include such information as how the originator selected the items on the list, what the invitees should do with the list, and the like. A sample message may state the following: “Hello all, this is my list for the top-ten scariest movies of 2008. I came up with this list by counting the number of times I had to cover my eyes during a scary scene. Have a look at the list and vote how scary you thought each movie was.”

Thus, in an embodiment the system allows the originator to share and develop the list with others. The originator may be interested in what others think of the items that the originator has initially nominated to be in his list. In a specific implementation, other users (i.e., participants or invitees) are invited to help develop and comment on the list.

List rules region 620 includes a number of options that allow the list originator to set the “rules” for what the participants will be able to do and how his list will work. For example, various embodiments include rules 648, 650, 651, 654, 660, and 666, and combinations of these rules. There may be any number of rules including no rules, one, two, three, four, five, six, seven, eight, nine, ten, or more than ten rules. The originator may decide on a rule by checking a checkbox, clicking a radio button, highlighting a rule in a selection or scroll box, entering information in an input box, or combinations of these.

Some examples of rules include rule 648. Rule 648 determines whether participants can add other nominees to the list or must select from the originator's list.

Rule 651 allows the originator to decide whether participants can see how others have voted before voting themselves or whether voting is anonymous.

Rule 650 allows the originator to decide whether participants can themselves invite other participants.

Rule 654 determines whether or not the list is password protected. For example, entering a password in an input box 657 will require participants to enter that password in order to access the list. Leaving the input box blank will allow participants to access the list without entering a password.

Rule 660 allows the originator to enter a deadline for voting before it is “closed.” For example, an input box 663 allows the originator to enter a time (e.g., 1:15 pm) and date (e.g., month, day, and year) that the voting will close. In another implementation, the originator may enter a duration of time in minutes, hours, days, weeks, months, and combinations of these and specify when the duration should begin. The list then appears with a countdown timer.

Rule 666 allows the originator to determine whether each new vote updates the list or whether the list is not updated until all the participants have voted (or the originator's allotted time has elapsed).

Voting may be implemented in any number of ways. In a specific implementation, the participants vote by rank ordering the nominees on the list. For example, a horror film enthusiast may create a list of the top ten horror films rank ordered from most scary to least scary. If the participant has a different opinion then the participant votes by reordering the list.

In another implementation, the participants may cast a vote for each item (i.e., nominee) on the list. For example, each participant may vote by assigning a numerical rating (e.g., 1 star, 2 stars, 3 stars, 4 stars, and 5 stars) to each nominee. A higher number of stars then indicates that the participant felt favorably towards that nominee. A lower number of stars indicates that the participant felt less favorably towards that nominee. The system then tallies the votes given to each nominee on the list to determine how the nominees should be ordered on the list. The nominee that received the most number of stars is placed at the top of the list. This is followed by the nominee that received the second most number of stars, and so forth.

A specific implementation of the invention may also include rules 669 and 672. Rule 669 includes an input box 670 that allows the originator to specify a fee that the participants must first pay. If the originator leaves input box 670 blank then no fee is required. Rule 672 includes an input box 675 that allows the originator to specify a subscription that the participants must pay. If the originator leaves input box 675 blank then no subscription is required.

The list making tool enables list originators to create “Fee” and “Subscription” lists. Fee lists will require that participants pay to view or vote on a list. Subscription lists will require payment by the participant for continued access. The amounts of the fees will be determined by the list originator (who will retain a percentage of them). Possible fee or subscription lists might include those which require significant ongoing work by the originator-perhaps review type lists, or those built from substantial or unusual research, or both.

The invited participant may be informed of the fee or subscription requirement via the e-mail invite. For example, the e-mail invite may state the following: “Dear invitee, after months of painstaking research, I have compiled a list of the ten most dangerous cities in the world. A fee of ten dollars is required before viewing the list. You may click this link to make your payment.”

Clicking on the link may take the participant to a third party payment processor where the user may complete their payment. When the payment has been confirmed, the third party payment processor sends a notification to the system. The system then responds with an another e-mail to the participant which now includes a link that the participant can click on to see the list.

FIG. 7 shows an example of invitee page 420. The invitee page includes an originator's or nominee list 705, a main list 708, a button 711 for submitting the invitee's list to the system, a new invitee region 714, a button 717 for sending the list to invitees, a text region 720 for explaining the terms of use, a button 723 for indicating agreement with the terms of use, a text region 726 for instructions, and a countdown timer 728.

The nominee list includes various fields such as a list title 730, a group name 733, an originator's name 736, a list number 739, and one or more item entries 742. These fields may all be prepopulated and noneditable by the invitee.

In a specific implementation, the item entries are displayed in rank order. That is, those items that the originator feels more favorably towards are displayed above items that the originator feels less favorable towards. An item entry includes an item name 745, a comment 748, and a play media user-selectable object (e.g., button or link) 752.

The nominee list allows the invitees to see which items the originator has nominated for inclusion on the list and the rank that the originator assigned. The invitee may also read any comments that the originator has included.

The invitee may also click the play media button to access any file that the originator may have associated with the item. For example, the list may be the top ten pop songs of the 1990s. Clicking on the play media button may then allow the invitee to hear a brief recording of the song. In a specific implementation, the recordings are stored on a central server. The recordings may be delivered to the participant's client device using any number of technologies. For example, in a specific implementation, the recordings are delivered to the client device via streaming technologies (e.g., QuickTime, Windows Media Player, Flash, Helix).

In another implementation, the recordings may be downloaded as opposed to streamed onto the client device. This allows, for example, the participant to download the recording and to later listen to it without having to be connected to the central server.

The main list includes one or more item entries 755. An item entry may further include various fields such as an item name 758, a comment 761, and a load media button 764.

In giving their input to a list, participants can use the default list “engine” which can be a drag and drop type method to drag nominees from the nominee list and drop them into the main list and then move them around on the main list until the desired ranking is achieved. As an alternative, participants can use another version of the tool that creates the ranking by forcing the user to pick from a series of pairings.

Finally, for those taking the list very seriously, they can enumerate and weight any number of criteria and the software generates a final list ranking from the values entered for each nominee. For example, criteria for the top fifty films may include popularity, historical significance, cultural impact, and award recognition. These criteria may be displayed as column headings adjacent to the nominee list. The participant, for each nominated film, may then select from a drop down list a value (e.g., one star, two stars, three stars, four stars, and five stars) for each criterion.

The countdown timer displays the time remaining until voting is closed. The time may be displayed units of days, hours, minutes, and seconds, or combinations of these. In another implementation the countdown timer includes the date and time, or both, that voting will close. Once the voting closes, the participant will be unable to make any changes to the nominee list.

The countdown timer may be omitted in some implementations. For example, the list originator may decide not to impose a time limit on when voting must be completed. In this case, the countdown timer is not displayed.

In a specific implementation, the invitee page includes a link to lists created by the other participants. For example, the invitee page may include a region that includes the usernames of all the other users who have been invited to participate in developing the list. Clicking on a username then opens a window which displays the order in which that participant ranked the nominees. This allows the participant to see how others have voted. However, if the list originator decided to prevent other participants from seeing the rankings of others then the other usernames will not appear. For example, the originator may decide that he does not want the participants to be biased based on how others have voted.

In a specific implementation, the participants are prevented from adding new nominees to the main list. Instead, the participants may only choose nominees from the nominee list to add to the main list. For example, the list originator may have decided to prevent participants from adding new nominees (see FIG. 6). In this case, the load media buttons will not appear on the main list and item name field 758 will not be editable. However, comment field 761 may be editable. This allows the participant to insert their own comments to explain, for example, the reason for their ranking.

If however, the list originator decided to allow participants to add new nominees then the load media buttons will appear and item name field 758 will be editable along with comment field 761.

The new invitee region includes a message to invitee input box 767 and an invitee e-mail address box 770. The invitee e-mail address box allows the participant to invite other participants by entering their e-mail address. The e-mail addresses may be separated by a comma, semi-colon, return, or combinations of these. In a specific implementation, an address book button 773 is provided. Clicking on the address book button opens an address book window. The address book window includes a list of contacts and a checkbox next to each contact. The user can scroll through the list of contacts and using the checkbox select which contacts to invite to the list. The system then automatically adds the e-mail address for the checked contacts to the invitee e-mail address input box. One benefit of this feature is that it saves the participant the step of having to always manually enter in the e-mail addresses of others he wants to invite.

The message to invitee box allows the participant to enter a message to the invitees.

When the participant is finished entering the additional invitees the participant clicks the send list button. The system then notifies these additional invitees via an e-mail which includes a link to the invitee page.

In a specific implementation, the new invitee region and the button for inviting new invitees is omitted. For example, the originator may have decided to prevent participants from inviting other participants (see FIG. 6).

Text region 720 describes the terms that the user must agree to before using the system. The terms may describe a privacy policy, a consent to receive promotions, dispute resolution procedures, and the like. The participant indicates their agreement by clicking the agree button. In another implementation, a checkbox may be used instead of a button.

In a specific implementation, the participant must first agree to the terms and click the button before they are permitted to make edits. For example, the participant may be prevented from dragging nominees from the nominee list and dropping them into the main list.

In another implementation, after the participant clicks the submit or send list button the system will check to see if the participant has clicked the agree button. If the participant has not clicked the agree button then the system will not accept the information. Instead, a new window will pop up and inform the participant that he must first agree to the terms before using the system.

FIG. 8 shows an example of list status page 423. The list status page includes an invitees yet to respond region 805, a contributors to list region 808, an invite new invitees region 811, a nominee list 814, and a text region 817 for instructions.

The contributors to list region includes a listing of the names of users who have contributed to the list either by voting on the nominees, adding new nominees, or both. In a specific implementation, the contributors' names are hyperlinked. Clicking on the contributors' names then pops open a window which shows how the contributor voted (i.e., ranked the nominees). That is, the window shows the contributor's list of items in ranked order which may be different from the nominee list.

The invitees yet to respond region includes a list of those invitees who have yet to respond. It includes fields such as a name of invitee 820, a message to invitee 823, and a send e-mail button 826. The name of invitee field is populated with the names of those invitees who have yet to respond, such as by voting. The message to invitee field is a text field that allows the originator to enter a text message to that invitee. The text message may be a friendly reminder urging the invitee to submit their vote. The message is sent to the invitee via e-mail after the originator clicks the send e-mail button. In the implementation shown, the system allows individual messages to be sent to each invitee who has yet to respond. One benefit to this approach is that originator may personalize the message to the invitee which may make it more likely that the invitee will then respond. In another implementation, each invitee yet to respond will get the same message.

The invite new invitee region includes a message to invitee input box 829 and an invitee e-mail address box 832. The invitee e-mail address box allows the participant to invite other participants by entering their e-mail addresses. The e-mail addresses may be separated by a comma, semi-colon, return, or combinations of these. In a specific implementation, an address book button 836 is provided. Clicking on the address book button opens an address book window. The address book window includes a list of contacts and a checkbox next to each contact. The user can scroll through the list of contacts and using the checkbox select which contacts to invite to the list. The system then automatically adds the e-mail address for the checked contacts to the invitee e-mail address input box. One benefit of this feature is that it saves the participant the step of having to always manually enter in the e-mail addresses of others he wants to invite.

The message to invitee box allows the originator to enter a message to the new invitees.

When the originator is finished entering the additional invitees the participant clicks a send list button 839. The system then notifies these new invitees via an e-mail which includes a link to the invitee page.

In a specific implementation, the nominee list displays the listing of nominees as initially entered by the originator. In another implementation, the nominee list may represent the combined or aggregate ranking of all those contributors who have thus far contributed. In yet another implementation, both the initially entered nominee list will be displayed along with the combined ranking nominee list. This allows the originator to see what the current status of the voting is and how the list has changed from what it originally was.

In yet another implementation, the originator may individually remove or include the votes from the contributors to see how the exclusion or inclusion of that contributor's vote affected the aggregate ranking. For example, the contributors to list region may include a checkbox adjacent to each of the contributors. The page may also include a button labeled “show aggregated list.” Checking the checkbox results in that contributor's vote being included in the aggregate ranking when the “show aggregated list” button is clicked. Unchecking the checkbox removes that contributor's vote from being included in the aggregate ranking.

FIG. 9 shows an example of search list titles results page 408. The search list titles results page includes a search list titles query box 905, a search list originators/groups box 908, and a search results section 911. The search results section includes search results 914, 917, and 920. There may also be a see more lists button 923.

The search list titles query box may be prepopulated with the user's query.

The search list originators/groups box may be empty. The user may, for example, decide to search on the originator/group name field as opposed to the list title field. So, the user can type the name of an originator or group in the box and then submit the query by clicking a search button, pressing the return key, or both. The system will then search on the fields originator and group and return the results in the search results region.

The search results section displays the results of the title search. That is, those list titles that matched the user's title query. The results may be displayed in any kind of format. Search results 914 and 917 show a first kind of format. In this format, items in the list are shown along with information such as a list title 926, a group name 929, and an originator name 932. An item may include a number 933, an item name 936, a comment 939, and a play media button 942.

Number 933 indicates the ranking of the item in the list (e.g., 1, 2, 3, 4, 5, 6, 7, 8, 9, and 10). Item name 936 is the name of the item.

In a specific implementation, comment 939 is a hyperlink. Clicking on the hyperlink opens a comments window which displays the comments that users have given for that particular item. The comments window may display the various comments from the different users in chronological order. Each comment include a time-stamp for the time and date that the comment was made and the name of the user who made the comment. A scroll bar may be included if all the comments do not fit in the comments window. In another implementation, the comments may be immediately viewable without the user having to click a comment link or button.

Clicking on the play media button opens any file (e.g., audio, video, slide show, picture, and text) associated with the item.

Search result 920 shows a second kind of format where a list title 945, a group name 948, and an originator 952 are shown, but not the items in each list.

In a specific implementation, the list title is a hyperlink. Clicking on the list title opens a new window that shows the items in the list.

One benefit to the second format is that more individual search results can be displayed at a single time because the items are omitted. This may be more appropriate for small screens such as screens on mobile devices. One benefit to the first format is that an additional click is not needed to see the items associated with the list title. Since this format requires additional screen space it may be more appropriate for larger screen sizes.

Clicking the see more lists button takes the user to a page displaying additional search results.

FIG. 10 shows an example of search list originators/groups page 411. The search list originators/groups page includes a search list titles query box 1005, a search list originators/groups box 1008, a lists by title box 1009, and a search results section 1011. The search results section includes search results 1014, 1017, and 1020. There is also a see more lists button 1023.

The search list originators/groups page is analogous to the search list titles results page. A difference is that the search list originators/groups page displays search results by originators/groups as opposed to titles as in the search list titles results page.

FIG. 11 shows an example of popular list by category page 414. The popular list by category page includes a search all list titles query box 1105, a search all list originators/groups box 1108, a lists by title box 1109, and a search results section 1111. The search results section includes search results 1114, 1117, and 1120. There is also a see more lists button 1123.

The popular list by category page is analogous to the search list titles results page and search list originators/groups page. A difference is that the popular list by category page displays search results by category. An example of categories include movies, music, restaurants, collectables, television, and everything else.

All the data available from each list originator, list, and list participant is stored in the list database. As a result, the list making tool Web site will be able to track a large number of consumers' interests and preferences and be able to reach each of them by e-mail. The Web site will also be able to present the opinions of a wide variety of groups on a wide variety of topics. Thus, visitors to the Web site can search for lists not just by topics but also by the groups whose opinion they value. So, if a person is considering what movie to watch next), they might be particularly interested in a “best of” list from the American Screenwriters Guild. Other interesting searches might include top ten Santa Monica restaurants as rated by Santa Monica residents or destination hotels in Thailand as rated by a group of travel book writers.

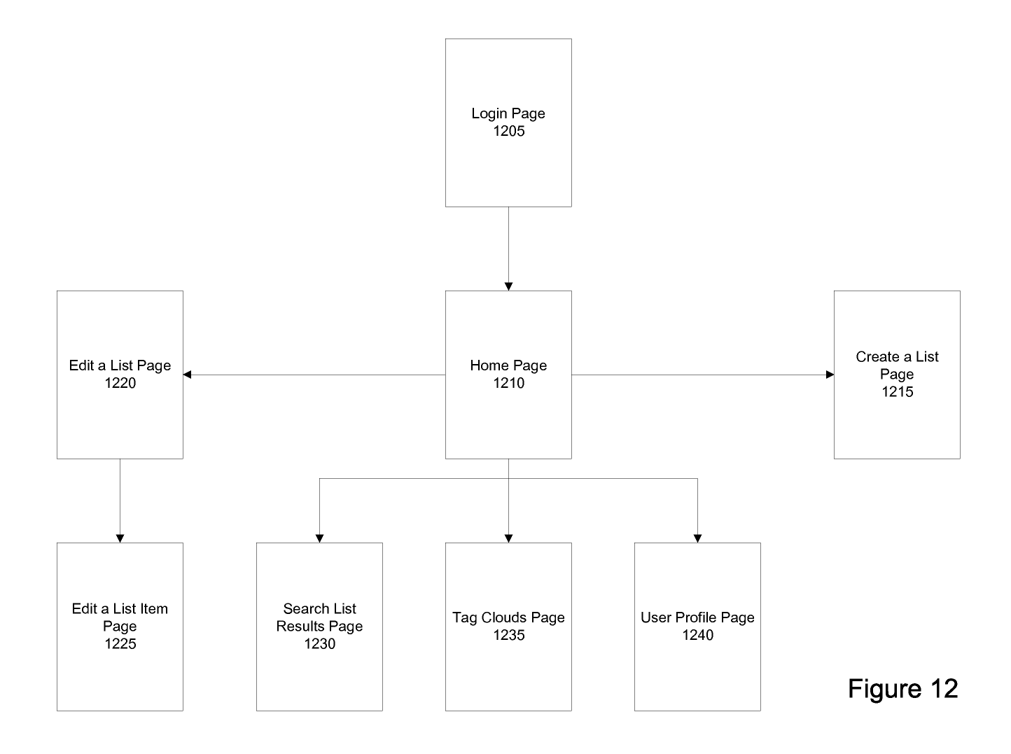

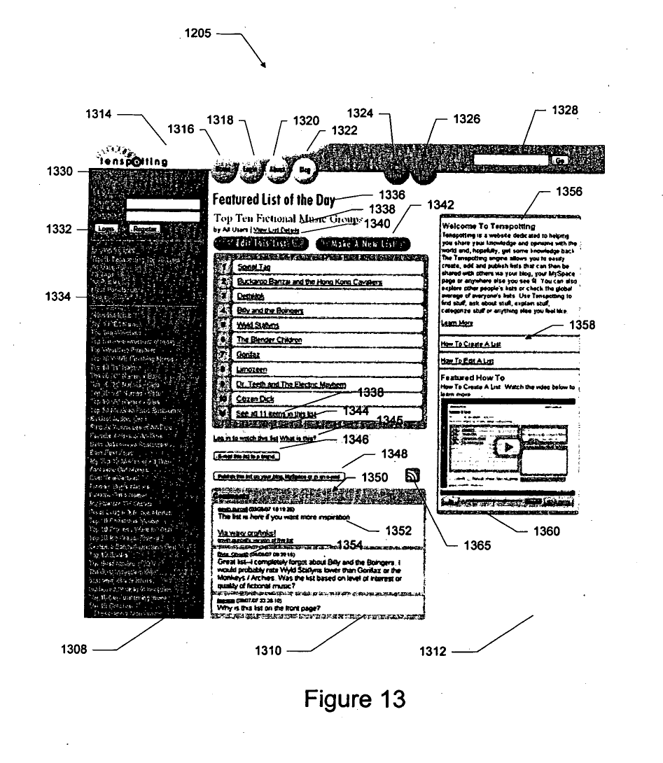

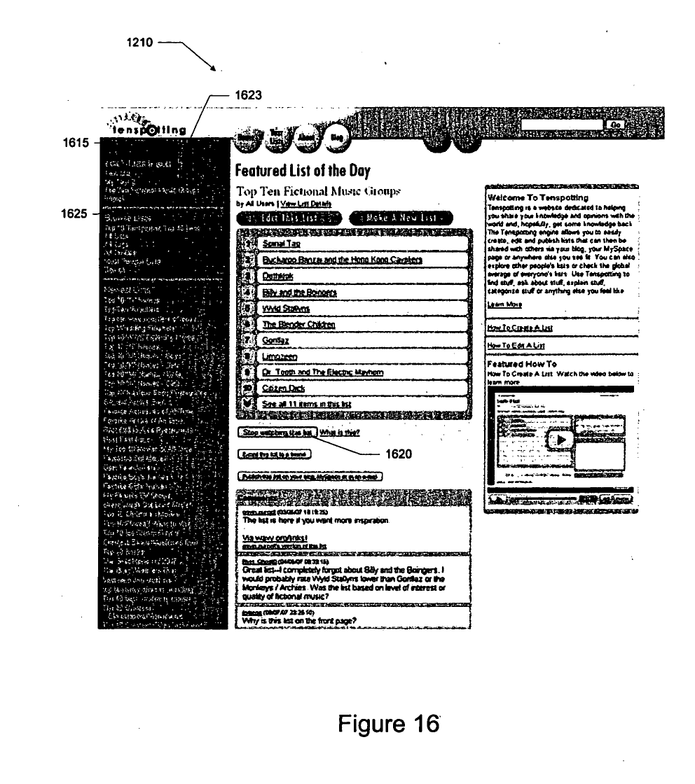

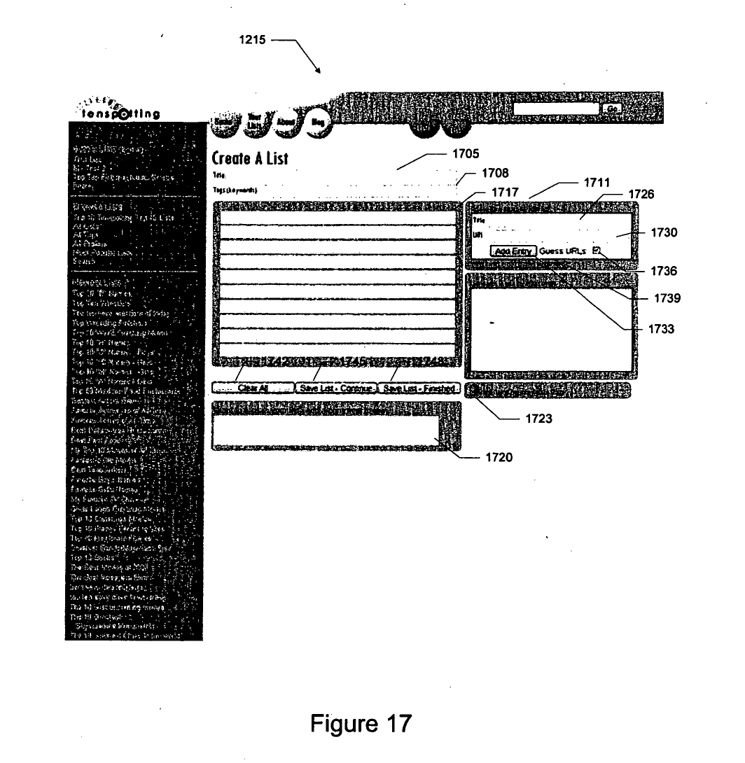

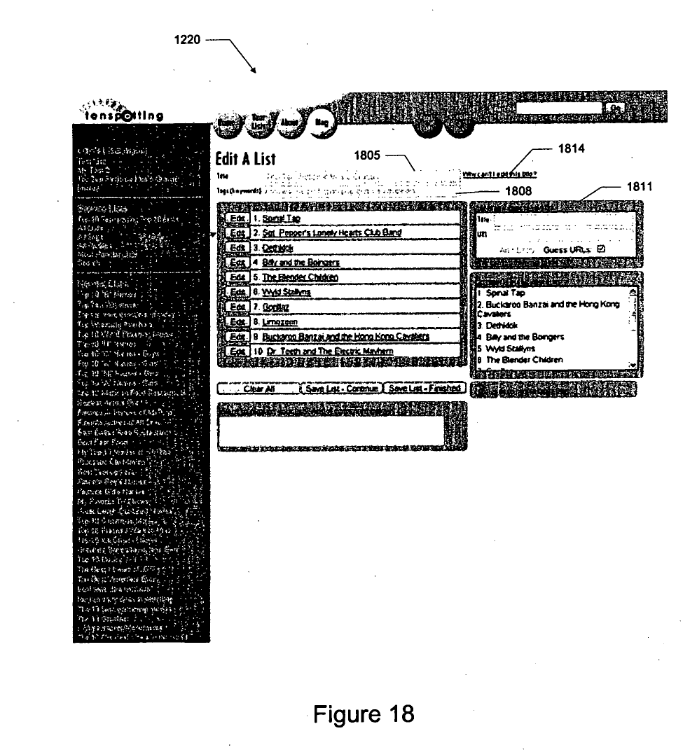

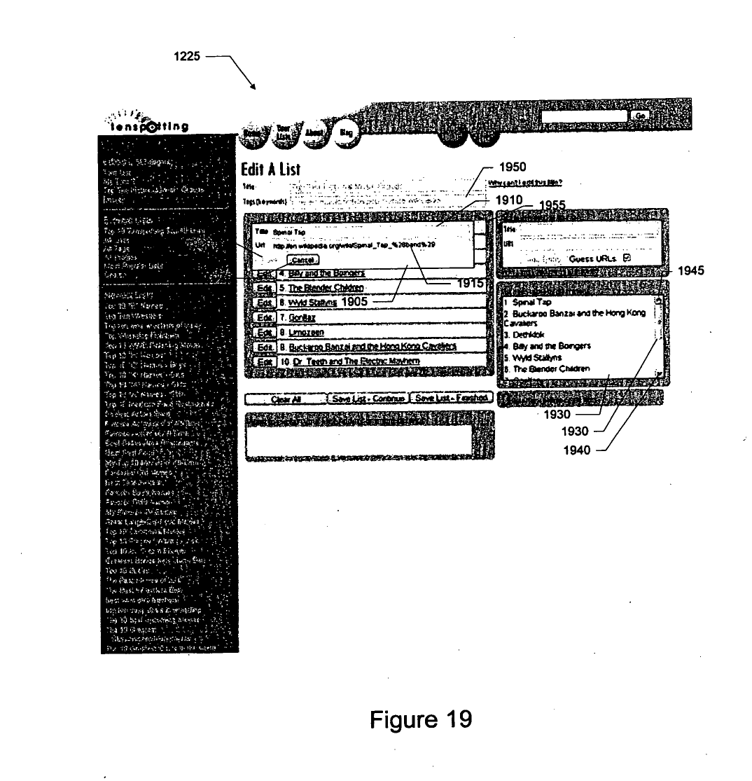

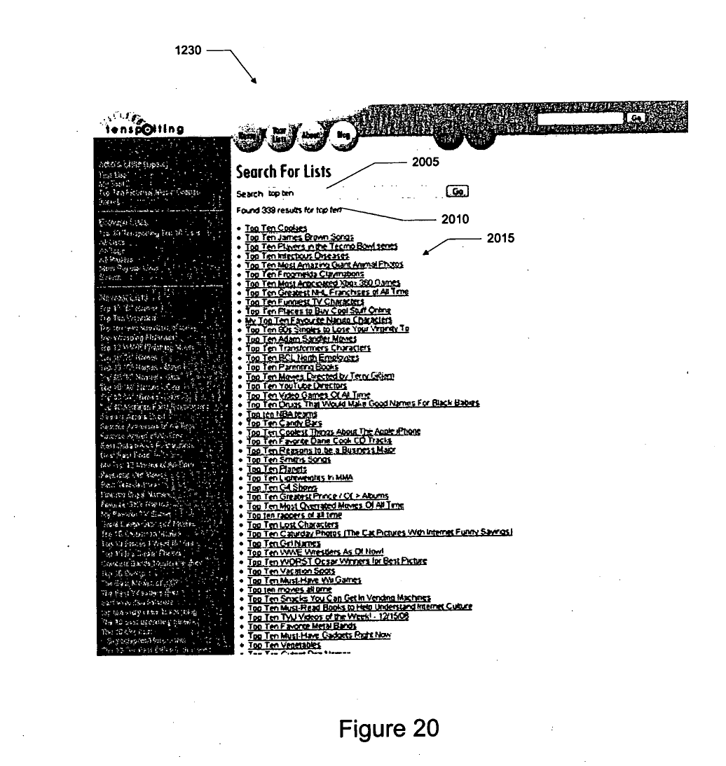

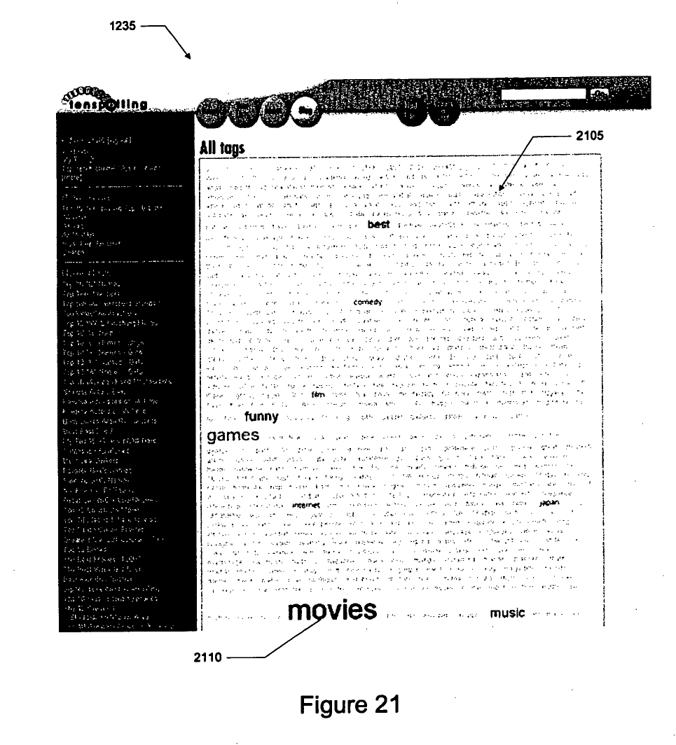

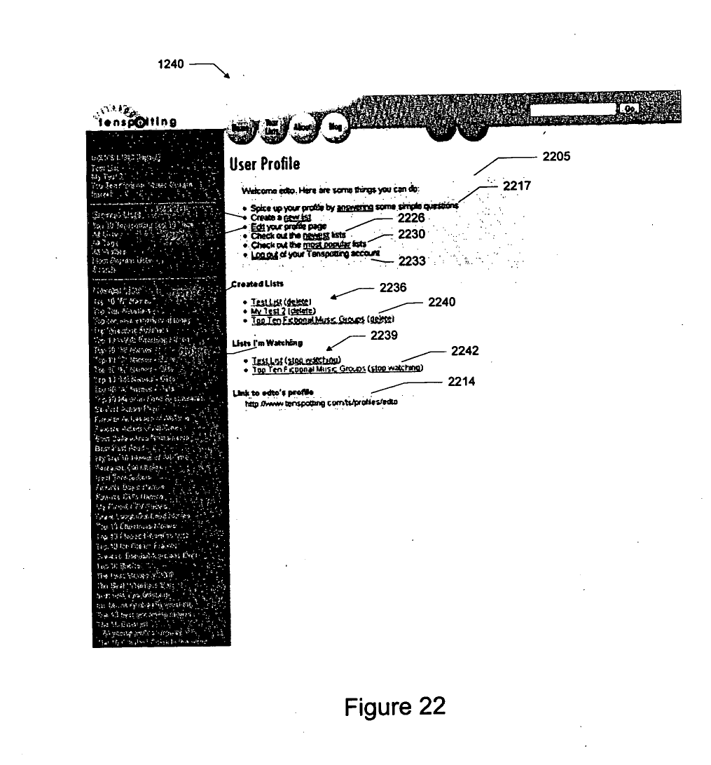

FIG. 12 shows a flow of a second implementation of the invention through Web site screens. The figure shows Web screens and arrows indicating flow from one screen to another. Page 1205 is a login page and a detailed view is provided in FIGS. 13, 14, and 15. Page 1210 is a home page and a detailed view is provided in FIG. 16. Page 1215 is a create list page and a detailed view is provided in FIG. 17. Page 1220 is an edit list page and a detailed view is provided in FIG. 18. Page 1225 is an edit list item page and a detailed view is provided in FIG. 19. Page 1230 is a search list results page and a detailed view is provided in FIG. 20. Page 1235 is a tag clouds page and a detailed view is provided in FIG. 21. Page 1240 is a user profile page and a detailed view is provided in FIG. 22.

FIG. 13 shows a detailed view of a first implementation of login page 1205. The page is divided into three main columns including a left column 1308, a center column 1310, and a right column 1312. The page also has a brand region 1314, a home button 1316, a login button 1318, an about button 1320, a blog button 1322, a find lists button 1324, a create list button 1326, and a search tool 1328.

The left column includes a login region 1330, a browse lists region 1332, and a newest list region 1334.

The browse lists region includes links to various lists that the user may find interesting. For example, the link “Most Popular Lists” takes the user to a page that displays any number of popular lists. The system may determine the popularity of a by, for example, calculating which list was most viewed, shared, e-mailed, edited, or the system may determine it by using other criteria. By clicking on the link “All Profiles” a user may browse through the profiles of other users and the lists these other users have created. Clicking on the link “All Tags” takes the user to a tag clouds page.

The newest list region displays in chronological order those lists that have been recently added to the system. A list may be hyperlinked such that clicking on the list takes the user to that list.

The center column shows a featured list of the day 1336, a view list details link 1338, an edit this list button 1340, a make new list button 1342, a login to watch this link 1344, a help link 1345, an e-mail to friend button 1346, a publish this list widget 1348, and a comments section 1350.

In a specific implementation, the featured list of the day is displayed as an ordered list where the position of the item in the list indicates the item's ranking. The system may determine the featured list of the day using any method. For example, the system may determine this list by calculating which list was most viewed, shared, e-mailed, edited, or the system may determine it by using other criteria. The list items are shown as hyperlinks. Clicking on the links takes users to additional information concerning that item. For example, if the item is the name of a music band then clicking on the link may take the user to the band's Web site.

If the list contains additional items beyond the number of items that are displayed then users may see these additional items by clicking a link 1338 to see more items. Any number of items may be displayed. For example, in a specific implementation, a user may create lists of up to ten items and these ten items will be listed. Multiple users may create lists of up to ten items. The system can aggregate these lists together for multiple users, where the aggregate list has more than ten items. However, in an implementation of the system, only the top ten items in the aggregated list are displayed to the user. See below for further discussion on list aggregation.

In other implementations, the system may display any numbers of items (or every item) in any list, an individual user's list or an aggregated list. For example, the system may display 5, 6, 7, 8, 9, 10, 11, 12, 13, 14, 15, or more items of the list. Or the system may display the top ten items and provide a link to see the other items in the list, the next ten items, or every item in the list.

This figure shows only a ten item list, but in another implementation more items may be displayed. In a specific implementation, registered users also have the option to set the number of items they want displayed in their lists. However, limiting the number of displayed items at any one time prevents users from becoming overloaded with information. Further, from a system implementation point of view, limiting the number of items may help improve system efficiency and speed, and reduce storage requirements for the system. Also, by having fewer items displayed, this will generally make it easier for displaying for users who are on mobile or portable devices (e.g., smartphones and PDAs) with smaller screens than a desktop computer or terminal.

Clicking the view list details link opens a new window that displays, for example, the name of the person who created list and their profile, the date the list was created, and like information.

Clicking the edit this list button takes the user to a page where they can edit the featured list of the day. Clicking the make a new list button allows the user to create their own list.

Clicking the login to watch this list takes the user to a login screen where they can either login or register. After logging in, the list is added to a user's watch list. The user is then notified of any changes to the list. Changes may include edits to the list made by other users, additions to the list, whether others have published the list, whether the list items have been added to other lists, and the like. The system may send notifications or alerts via e-mail, text messages, or both. This helps the user stay abreast of any changes to the list.

There are several ways in which the user can share the list. The users can inform others of the list by, for example, e-mailing others the list by clicking the e-mail this list to a friend button.

The user may also publish the list to a blog or other social networking site. For example, the figure shows widget 1348. This widget allows publishing of the list to the blogs and social networking sites listed in the widget. In an implementation, the system pushes the list automatically to these other Web sites. In another implementation, a user may copy a uniform resource locator or URL pointing to the list and paste the link into a Web site of their choosing.

The system may then respond by opening a window containing programming code (e.g., html code), a universal resource locator (URL) that takes another user to the list, or both that the user can copy and paste into, for example, their blog, MySpace profile, or e-mail.

The system allows for distribution of list content, list widget content, or both through multiple forms. An example of one form is a Web feed format such as really simple syndication, resource description framework (RDF) site summary, rich site summary, and combinations of these. These formats may be referred to as RSS. Thus, in a specific implementation, the system includes an RSS feed icon 1365.

Clicking the RSS feed icon allows the user to subscribe to an RSS feed, unsubscribe to an RSS feed, change options associated with an RSS feed, and the like. An RSS feed may include changes to a particular list (e.g., item additions, item deletions, and item reorderings), new lists added to a particular category of lists, addition of a list to another user's watch list, removal of a list from another user's watch list, and the like.

This feature offers several benefits. For example, one benefit is increased range of distribution and simplicity for reading the list, list widget content, or both in existing Web browsers, RSS readers, or both.

The comments section includes any number of comments 1352 that other users have made concerning the featured list. A comment entry includes a hyperlinked username 1354. In a specific implementation, clicking on the username opens a window that displays profile information concerning that user. A comment may be time and date stamped as shown.

Typically, the comments are arranged in reverse chronological order with the most recent comments first. However, in another implementation, the comments may be arranged in chronological order with the most recent comments last. In another implementation, there is a button that allows the user to toggle between chronological and reverse chronological views.

The comments may include, for example, criticism and opinions concerning the list items from other users.

The right column may include an introductory text 1356, help links 1358, a how-to-video 1360, or combinations of these.

The introductory text introduces users to the system, the system's purpose, and its benefits. Help links such as how to create a list and how to edit a list take the user to tutorials that describe how lists are created and edited. The how-to-video may be a short movie that demonstrates, for example, how to create a list, how to edit a list, how to search lists, how to give comments, and the like.

In an implementation, the system does not require users to register or login to enjoy certain benefits of the system. For example, users may still browse through various lists, search lists, e-mail lists to others, or publish the list to other sites (e.g., blogs and social networking sites). However, some features of the site will require the user to register and create an account. This may include, for example, editing lists. Thus, when an unregistered user clicks on a link that requires registration, the system will show a screen that invites the user to register.

The blog button takes the user to a blog. The blog may be, for example, the user's blog, a random blog determined by the system, a blog maintained by a system administrator, a blog related to the list, or other type of blog.

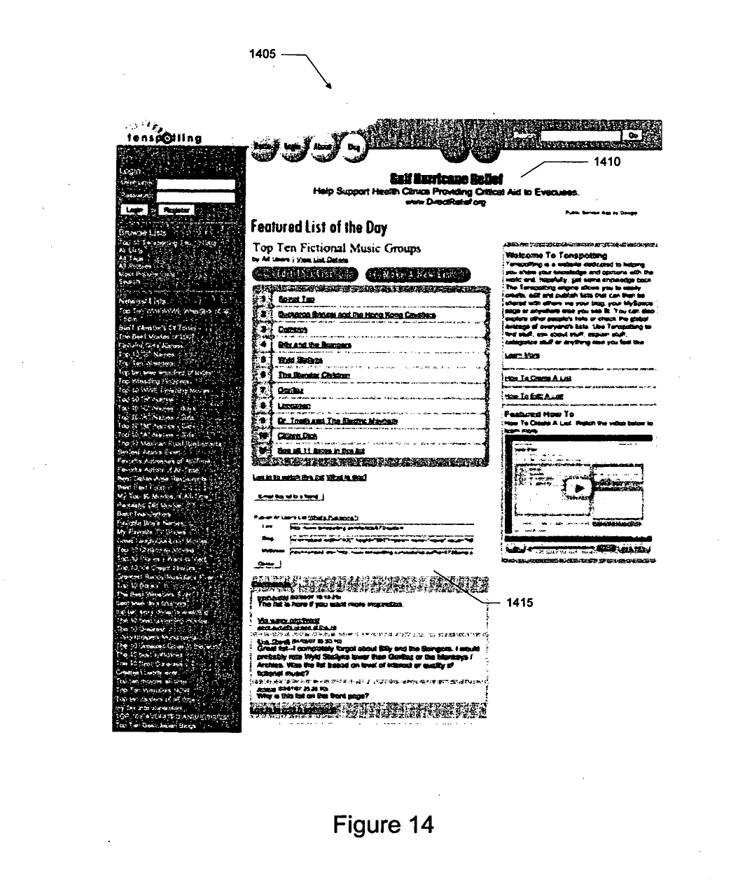

FIG. 14 shows a detailed view of a second implementation of a login page 1405. The login page includes an advertisement banner 1410. The advertisement banner may be any size. For example, the advertisement banner may be about 6 percent of the page size. However, the advertisement banner may range from about 3 to about 20 percent of the page size. For example, the advertisement banner may be 5, 10, 15, 20, or more than 20 percent of the page size. In other implementations, the advertisement banner may be less than 5 percent of the page size.

Although FIG. 14 shows the advertisement banner at the top of the page, in other implementations the advertisement banner may be located in other places. For example, the advertisement banner may be displayed on a side of the page (e.g., right side and left side), at the bottom of the page, or both.

A specific implementation may include more than one advertisement banner. For example, an implementation may include two, three, four, five, six, or more than six advertisement banners.

It should also be appreciated that the advertisement banner may be displayed on any page, multiple pages, or both of the system. For example, the advertisement banner may be displayed on the home page, share list page, invitee page, search results page, category list page, create a list page, edit a list page, edit a list item page, tag clouds page, or user profile page, and combinations of these. Furthermore, an implementation may include the advertisement banner displayed in a separate pop up window, Web page, or both after the user makes a selection. For example, the advertisement banner may appear in a separate pop up window after the user clicks any button, link, or both on the page. For example, after the user clicks the log in to watch this list link, the system may display an advertisement before taking the user to the login page.

The advertisement banner may be contextually sensitive. For example, the fictional music groups shown in FIG. 14 may be performing a benefit concert for hurricane victims. The content of the advertising may relate to the subject of the list, items in the list, an attribute in the user's profile (e.g., geographic location) or usage history, or a combination of these. For example, if the list is about music groups then the banner may display one or more merchants where albums may be purchased. Likewise, if the list is about the best restaurants in San Francisco, then the banner may display advertisements from various San Francisco restaurants.

In a specific implementation, the system performs further advertising optimization by analyzing the user's profile information, system activity (e.g., amount of time spent using the system), content (e.g., categories of lists created), and combinations of these to identify advertisements that are most relevant to the user.

The system may combine data points from lists created by the user, the relative position of the items in the list, list types, list visits, content types selected, or demographic profile information, and combinations of these. The system may then use this information to determine which advertisements to display to the user. For example, a user who frequently creates lists of what he believes to be the best digital cameras may see an advertisement from a digital camera manufacturer to purchase a new digital camera at a reduced price with the agreement that the user submit a review to of the camera to the manufacturer. This feature of the invention allows, for example, the manufacturer to discover knowledgeable and perhaps influential users of their product.

The system may present these premium advertisements on behalf of companies willing to pay additional fees for this service since the likely engagement rate by the user may be higher than that of a normal contextual advertisement or general banner advertisement which may not combine multiple data points concerning the user.

The example in FIG. 14 also shows code 1415 generated by the publish this list widget shown in FIG. 13. The user can then copy the code and paste it into another application (e.g. blog, MySpace, and Facebook).

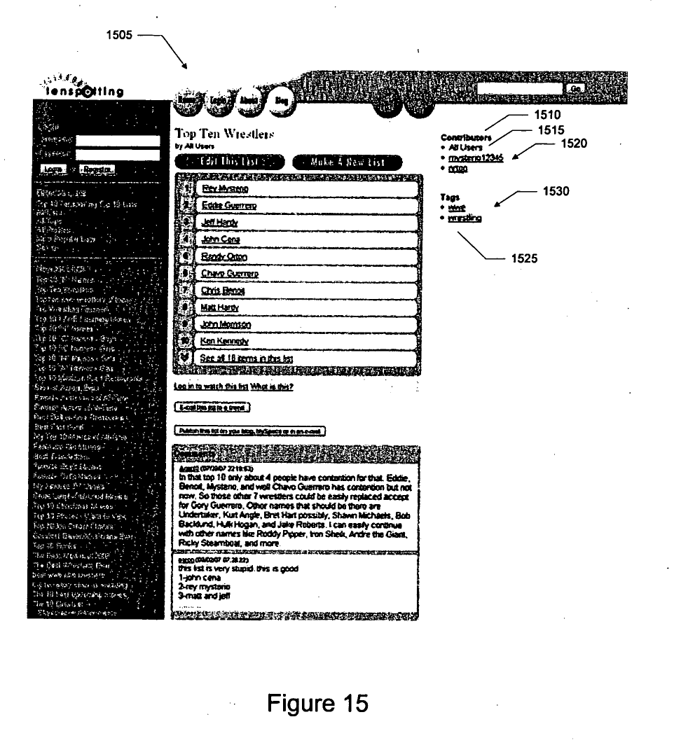

FIG. 15 shows a detailed view of a third implementation of a login page 1505. The login page includes a contributors section 1510. The contributor's section includes an all users link 1515 and any number of usernames 1520 as links. Also included on the login page is a tags section 1525 with any number of tags 1530 displayed as links.

Clicking on the different links in the contributors section toggles the list between the various contributors to the list. For example, in a specific implementation the system allows multiple users to contribute to a list by, for example, voting through reordering the list items. The system then aggregates the different lists into a single list via an algorithm. The list shown in FIG. 15 is an aggregated list as indicated by the highlighted all users link. However, the user can click on the usernames of other contributors listed in the contributors section to see how that contributor thought the list should be ordered. For example, clicking on the username mysteriol 2345 will show who mysteriol 2345 believes are the top ten wrestlers.

What items appear in the aggregated list and their order in the aggregated list may depend on many factors. For example, these factors may include the number of times the item appeared in the lists of the contributing users, or other users in the system. Additionally, the items may be weighted according to the order that they appeared in these other lists (i.e., a weighted average calculation). The factors could also include characteristics of the contributing users. For example, a contributing user who frequently creates lists may be weighted differently from a contributing user who does not create as many lists.

A user may select which contributors to create an aggregated list from. For example, the user may select as contributors only those who are in the user's network, or the user may select every user in the system.

Alternatively, the user may select as contributors only those users who are in a certain geographic region, who are of a certain age, who have a certain education level, who work in a certain industry, who have a certain user rating, who have created a threshold number of other lists, or who have other specific attributes. Such attributes may be stored in a user profile.

In an implementation, this pick-and-choose contributors feature may be implemented via a drop down box in the contributors section. The drop down box may include choices such as include all list contributors in aggregated list, include only contributors in my network, include only contributors who live in California, include only contributors who are over 18, and the like. In another implementation, these choices may be implemented as checkboxes. Using checkboxes allows the user to combine choices (e.g., show me an aggregated list based on contributors in my network who live in California).

The tags section includes any number of clickable links. In a specific implementation, these tags are used as a method of list categorization. For example, clicking on the tag wrestling will take open a window that displays other lists in the wrestling category.

FIG. 16 shows an example of home page 1210. The home page includes information similar to the login page. One additional feature is a user profile region 1615. Another additional feature is a stop watching this list button 1620.

The user profile region includes, for example, titles 1623 of various lists that the logged-in user has created. These titles may be hyperlinked so that clicking on them takes the user to that list. Any number of links may be displayed in the user profile region. This includes, for example, one, two, three, four, five, or more than five links. In a specific implementation, only a subset of the user's links are shown such as three. A more link 1625 allows the user to see the other links that he created.

Clicking the stop watching this list button removes the list from the user's watch list. For example, the user may no longer be interested in tracking the changes to the list “Top Ten Fictional Music Groups.”

FIG. 17 shows an example of create a list page 1215. The page includes a title input field 1705, a tags input field 1708, an item input box 1711, a main list region 1717, a comments input field 1720, and a trashcan 1723.

The user enters the title of their list in the title input field. The user may also enter any number of tags or keywords in the tags input field. The tags or key words may be used as an index to aid in searches.

The item input box includes an item title input field 1726, a URL input field 1730, an add entry button 1733, and a guess URL checkbox 1736. A specific implementation may also include a link 1739 that the user can click on to get help.

The user enters the title of their item in the item title input field. As the user types the name of the item the system shows the user other list item names the user may wish to select from. These other list items may be shown in a drop down list box of the item title input field. These other list items may be items with similar names. For example, as the user types the words “Led Zep” the system displays in the drop down box the list “Led Zeppelin, Led Zeppelin II, Led Zeppelin III, Led Zeppelin IV.” The user may then select one of the values using, for example, a pointing device such as mouse without having to type the complete item name. This predictive text feature speeds entry and reuse of list items.

A URL that the user wishes to associate with the title may be added in the URL input field. When the user has completed entering an item they click the add entry button. This causes the item to be added to the main list region. The titles appear as hyperlinks. Clicking on the title take the user to the page specified in the URL associated with the item. The URL may be a reference to a revenue generating affiliate.

By checking the guess URL checkbox, the user can let they system guess what the URL is based on what the user entered in the item title field. For example, if the user enters the name of an album in the item title input field the system automatically provides a URL that is a link to the artist who created the album. The system may perform this “guessing” using any algorithm. For example, in a specific implementation, the system concatenates the value the user entered in the item title input field. The system then uses this concatenated value as part of the URL.

The main list region, in addition to displaying the items entered by the user, also includes a clear all button 1742, a save list—continue button 1745, and a save list—finished button 1748. Clicking the clear all button deletes all the items from the main list region. For example, the user may decide that they do not like their list and wish to start a new list. However, if the user wishes to just delete a single item they can drag that item from the main list region into the trashcan.

The save list—continue button allows the user to save a draft of their list for editing at a later date. In a specific implementation, this draft list is saved to a central server. The user can then later resume working on their list. For example, the user may want to give some additional thought to their list or do additional research before publishing it. Clicking the save list—finished button causes the list to be published and thus accessible by others on the system.

The comments input field allows the user to attach other descriptive text to their lists. For example, the user may explain the method through which they arrived at their list. In a specific implementation, this field is also searchable.

FIG. 18 shows an example of edit a list page 1220. The page includes edit buttons 1801 next to each item in the list.

The page also includes similar fields as those shown in FIG. 17. For example, the edit a list page includes a title field 1805, a tags input field 1808, and an item input box 1811. There is also a help link 1814. However, in FIG. 18, these fields are grayed-out and noneditable. This figure shows an example of what a user who is not the list originator may see. That is, the user may be a participant or invitee to the list. In this case, the participant may only be permitted to edit the list by rearranging the order, adding new items, or both.

Help link 1814 includes help text that explains why the user is prevented from editing certain fields. The help page may also include other helpful information such as how to publish and share the lists, how to aggregate lists, how to comment on lists, or how to search lists.

Clicking the edit button allows the user to edit that particular item as shown in FIG. 19.

FIG. 19 shows an example of edit list item page 1225. In this instance the user has clicked on the edit button from FIG. 18. A window 1905 pops up. The window includes an item title input field 1910, a URL input field 1915, a done button 1920, and a cancel button 1925. There is also a list items in use by others box 1930.

In a specific implementation, the list items in use by others box is a scroll box with a scroll bar 1935 and scroll arrows 1940 and 1945. The user can drag the scroll bar to cause scrolling in the direction of the drag. The user can also click the scroll arrows to peruse the contents of the scroll box.

The list items in use by others box shows the user items that other users have added to the list. Any number of items may be shown at an instance. For example, in FIG. 19, six items are shown. However, other implementations may show more than six items at a time or less than six items at a time. A user then uses the scroll bar, scroll arrows, or both to see more items.

In various embodiments, the system shows items in order of most recently added (e.g., newest items to oldest items), items in rank order (e.g., highest ranked items to lowest ranked items), and items in alphabetical order. In a specific embodiment, the username of the user or users who added the item may also be shown in the scroll box. For example, one or more usernames may be displayed in brackets after the item.

In a specific implementation, the list items in use by others box may include similar items that have been included on other lists. For example, based on tags 1950 for main list 1955, the system may search other lists for similar tags. Items from these other lists may then be shown in the list items in use by others box. The user can then select these items (e.g., double clicking) for inclusion into their own lists. Thus, the user may create lists by taking lists and lists items from other users and removing and adding list items to create their own lists. Further, a user may receive a list (e.g., via e-mail or accessed through the Web site) from another user and reuse items in this list to create a new list.

In a specific implementation, the system allows reuse of content from third parties (e.g., YouTube, LastFM, and Amazon) to create the list. For example, if the title of the list includes the words “fiction books” then the system may display in a box a list of fiction books for the user to choose. The list of the books may be from third parties such as Amazon.

In a specific implementation, the system also displays the number of times other users have added the same or similar items to their lists. For example, an item in the list items in use by others box may include a number in brackets. This number would indicate the number of times other users have included that item in their lists.

The list items in use box has several benefits. For example, it allows the user to peruse the complete list of items that have been added to the list. Simultaneously, the user can also see a subset of those top-ranked items in the main list. The user can then compare the top-ranked items with the other items in the list. Furthermore, the list items in use box helps to facilitates reuse of list items, speeds item entry, facilitates normalization and aggregation of list items, and facilitates establishing connections between different lists with common list items.

The user may edit the item by entering in a different item and URL. The user may also select an item from the list items in use by others box to include instead. If the user changes their mind then they can press the cancel button and the item will revert to the original item. If the user is satisfied with their changes then they can press the done button and the edited item is saved.

The user may also edit the list by reordering the items. In a specific implementation, reordering is accomplished by, for example, clicking and dragging an item from one location in the list to another location in the list.

As in the list creation page, the user may save a draft of the list to continue editing at a later date. The user can also clear the list with a single click. When a user is finished with the list, they can save it. In an implementation, after the list has been finalized and saved, all other users including registered and unregistered users may see the list. In other implementations, only registered users can see the list. These lists are private or confidential lists. In yet another implementation, only users in the user's network or those users who are invited may see the list.

FIG. 20 shows an example of search list results page 1230. The page includes a search tool 2005, a results summary 2010, and a list of search results 2015.

The user searches by entering key words into the search tool. The system's search engine may include in the search the list title, items in the list, other users, comments associated with the lists, or combinations of these. The returned results are hyperlinked. Clicking on the link takes the user to list items, comments, or the profile of other users. The system may display the results in many different orders. For example, the results may be displayed alphabetically, by popularity, in decreasing or increasing order the number of comments, and the like.

FIG. 21 shows an example of tag clouds page 1235. The page includes any number of clouds 2105. These tag clouds are displayed with various visual representations that represent a data dimension. A tag cloud may link to a list related to that cloud tag. For example, clicking on a “movies” tag 2110 may take the user to a list of popular movies.

In an implementation, the system displays key words about the various lists as tag clouds. These tags are linked to lists covering the subject of the tag. Tag clouds are shown in various visual cues including line weights, colors, and sizes. The visual cues may also be animated. These visual cues may provide, for example, an indication of the number of times that key word has been entered in a search, the number of times that key word has been included in a list, or both.

For example, the “movies” tag may have been the most frequently searched key word. Thus, this tag is given the largest font size. The system then displays the other tags in smaller sizes in which the size similarly corresponds to the frequency of search. Thus, by using cloud tags, the system provides a view of emergent tags, i.e., those tags that are becoming increasingly searched. Other factors affecting the characteristics of the visual cues may include the popularity of the tag, i.e., the number of times the tag has been used as a key word in a list, or the importance of the list the tag links to as determined by a list rating system. Many other factors influencing the visual cues are possible. The differences in visual cues among the tags allow the user to see various trends.

The cloud tags may appear in alphabetical order, in a random order, or be sorted by weight. In an implementation, the cloud tags may be clustered categorically so that similar tags will appear next to each other.

FIG. 22 shows an example of user profile page 1240. The page includes a things you can do section 2205, a created lists section 2208, a lists I'm watching section 2211, and a user's profile URL input field 2214.

The things you can do section includes a number of links that highlight various features of the system. The section includes a profile questions link 2217, a create a new list link 2220, an edit profile page link 2223, a newest list link 2226, a most popular list link 2230, and a logout link 2233.

The profile questions link helps the user enhance their profile by posing various questions to the user. For example, the questions may be related to the user's favorite band, least favorite band, favorite hobby, least favorite hobby, favorite food, or least favorite food.

The edit profile page link allows the user to edit their profile information such as their name, interests, background, and contact information (e.g., e-mail address, mailing address, phone number).

The created lists section includes a listing 2236 of the lists that the user has created. These lists may be linked by their titles. Clicking the title opens a window that shows the items for that list. The user may also delete a list they created by clicking a delete link 2240.

The lists I'm watching section includes a listing 2239 of the lists that the user wishes to be alerted for changes to. These lists may be linked by their titles. Clicking the title opens a window that shows the items for that list. The user may also remove a list from their watch list by clicking a stop watching link 2242.

In a specific implementation, other users may also have access to certain profile information of other users. For example, by clicking on a username, the user may see lists created by that username. This allows users to discover additional common interests with other users and facilitates social interaction.

The user's profile URL input field allows the user to copy the URL and paste or embed it into other Web sites. For example, the user may copy the URL into the user's profile on another social networking site. Clicking on the URL from these other Web sites then takes opens the user's profile page 1240.

In an implementation, the system integrates with existing social networking systems, standards driven social networks microformats, or both. Some examples of microformats include XHTML Friends Network (XFN) and Friend of a Friend (FOAF). The system allows users to extract information from social networking systems including friends, groups, or demographic profile information, or combinations of these. When integrated with the system, this data allows for additional control over permissions as well as enhanced demographic data that may be used to filter list results.

In an implementation, there are “certified” lists which are lists that the list making tool Web site has done some level of authentication for. So a site visitor who does a search trying to get a recommendation for a Santa Monica restaurants as rated by Santa Monica residents will have some reason to believe the list participants are actually Santa Monica residents (unlike the uncertified lists, who could really be by anyone because they are unaudited). How the list making tool would do the auditing would depend on the list (for the example given, zip code filtering of some kind would suffice perhaps, or limit participants to people responding to outbound e-mails to a Santa Monica mailing list).

The database will also track how much revenue (see discussion below on Revenue Model) each list generates from advertisements served in connection with the list. As each list originator will have the option to receive a share of this amount (or have that share automatically sent to one of our preselected charities or input one of their own), some of the originators will often visit the Web site page displaying how much they have earned (which view will not be accessible to the other list participants).

People generally understand the concept of a top ten list. It is a useful tool in almost any attempt to determine or find a “best” of anything. This has application to both halves of the business: the list making tool and the home page's list searching service.

The list making tool will be a very simple, intuitive, fun way to organize and distribute a ranked list. Creating a group list is a common task but one for which there is not presently a widely available product, online or off. Most people creating such a list would just send an e-mail to a distribution list or post a list on a blog. Gathering and organizing the responses of others to a list becomes an increasingly cumbersome task with each additional user's input.

A group's top ten list is similar to a blog in some respects. Though of course of much briefer duration, a top ten list serves as a focal point to define, refine, and communicate the group's collective opinion on a topic of interest. It's like a blog in its ability to “accessorize” a community, but it requires only a minute's worth of attention to understand a significant amount of information (i.e., the meaning of the list and interrelationship between the items on it). At least in this sense, a list is a far more effective communication tool than blogs, e-mails, and other prose dependent media.

There are many varieties of lists that may find a home on the list making tool Web site-several examples are listed below. The key variables defining a list are topic, purpose, geographic focus, content format, and originator. Some lists are for ranking a particular kind of product available for purchase nationwide, others are more about services to be found at a local level. Some lists are published as a public service, others as a means to make the originator's point. Some lists will be made up of video clips others will be just simple text, pictures, or audio. The nature of the community will be what determines the list that interests it.

Sample Lists

| List | Content | Originator |
|---|---|---|
| Top ten gadgets for travelers | Images, description of | Wired magazine |
| in 2007 | gadgets; rationale for | |
| | ranking; links to sites selling | |
| | the gadgets | |
| Top ten gangster movies of | Text description; video clips | Screenwriters Guild |
| all time | of highlights; rationale for | |
| | ranking | |
| Top ten funniest clips on | Links to YouTube clips or | Individual posting the list(s) |
| YouTube or my top ten | links to download songs; | on their MySpace page |
| favorite songs | commentary | |
| Top ten stupidest (or | Video clips of Bush | Democratic (or Republican) |
| smartest) Bush quotes | speeches | political action group |
| Top ten best Santa Monica | Text description; contact | Peachhead—a family related |
| pediatricians | information; maps; rational | blog for Westside mothers |
| | for ranking | |
| Top ten worst hospitals for | Text description of hospital; | Nurse's association. |
| patient care in LA | rational for ranking. | |
| Top ten knock knock jokes | Text and/or audio of joke | Anyone |
| Top ten hottest downtown | Text description, | LA young professionals |
| LA clubs | commentary re clubs; hours | organization |
| | and address; map of location | |
| Top ten “cutest” boys at | Images; text commentary | The girls of that high school. |
| particular high school | from the list participants. | |
| Top ten “hottest” super | Images; text commentary | Open list to all corners |
| models | from the list participants. | |

Given that a specific embodiment of a revenue model of the list making tool Web site will be primarily advertising driven and that list originators will get to share in the revenue generated by their list, some list makers will be motivated by profit to create and maintain a compelling list or lists with broad appeal. A cottage industry of sorts could develop in which microentrepreneurs look to make a little bit of money by promoting their lists. Groups may use the lists and the revenue they generate for their originator as a way to quickly and easily monetize the group's informed, credible opinion. For example, the American Screenwriters Guild may want to publish a series of movie top ten lists (e.g., gangster movies, romantic comedies, thrillers, and others) and use their share of the resulting revenue to fund grants for screenwriters or other guild initiatives. A presidential candidate could publish the top ten things he will do as president and then distribute it to his support base with instruction that they in turn send it to all of their friends and family—the resulting list revenue goes to fund his campaign.

The search service of the list making tool Web site will have broad appeal once there is a critical mass of lists and site awareness because the service will meet a presently poorly fulfilled need. Attempts to find a “best of” a particular category will likely include a measurable portion of all queries to the online search engines. People are frequently going to Google or other search providers to answer questions like: What is the best camcorder? What is the best Santa Monica That restaurant? What are the best romantic comedies? And there are many other “what is” questions. Most often the typical search provider only responds with links to out of date, unresponsive content about a particular camcorder, restaurant, or movie. There is rarely any content relating the items in a category to one another in terms of quality or desirability. People generally have to spend a great deal of time and effort slogging through a bunch of different links to piece together their own ranking.

A big part of the reason for the scarcity of ranking type content is because of the relatively large expense and continuous effort required to produce and refresh such content. An implementation of the invention, by contrast, should have wide, up-to-date ranking information because its content is generated by a motivated, informed, diverse body of originators. Equally important, the list making tool Web site will publish the originators of a list. This allows anyone reviewing the list to evaluate the credibility of the list. So, for example, some unknown third party's opinion of top ten laptops may not be that compelling (though there is some inherent value just by virtue of the fact that the originator went to the trouble to make the list), but if the list is from a trustworthy source such as PC Magazine, or a group of heavy laptop users, it might be of real interest. Groups with credibility on a topic are provided an easy way to publish and potentially monetize their opinion.

In addition, users effectively make the searching of their lists effective by creating titles for them. Searching by list title should yield highly responsive responses to queries because originators will naturally title their lists to accurately describe their content. This amounts to high quality metatagging by the originators. This again compares favorably to the major search engines which often generate a high percentage of unresponsive returns to search requests.

In an embodiment, a Web site of the invention will primarily generate revenue by selling advertising space. Given insight into users' interests, preferences and relationships, advertisers will have the ability to target their ads to the right audiences. Companies selling movie DVD's for example can advertise next to all of the lists with the word “movie” in the title. If enough site traffic is achieved, an auction model could be developed to sell such advertisements. However, in the short term, third party ad serving services can be used to quickly and cheaply monetize site traffic. Given the model, the amount of revenue earned will be driven by the number of page views the Web site of the invention serves. The Web site should generate a large number of page views through the list making tool and its home page search service.

The list making tool is by its nature extremely “viral.” The originator e-mails out the list with its embedded ads to his invited participants. Each of them then may redistribute the list to people they think will find it interesting. Each of the resulting list participants then receives e-mails from the site to update them as to list activity (e.g., a new person has voted, the list is complete, new nominees have been added, and others). Many people who participate in a list originated by others may then think of a list of their own they would like to originate.

The home page should also ultimately drive a large amount of traffic. As the tool proliferates, the number of lists grows and other marketing initiatives gain traction, visitors will begin to search the existing lists. Eventually, queries will pull up multiple responsive lists. When a user clicks on a list, that list will be served by the Web site of the invention along with its embedded advertising (unlike the major search engines which direct users to third party sites). If a user likes a list, he can also elect to see other lists by the same originator-again resulting in more page views. Some lists will be regularly updated by their originators (e.g., best new video on YouTube, top ten news stories) and so invite regularly returning traffic.

In a specific implementation, in order to motivate list participants, a percentage of all revenue generated by a list will be shared with its originator. The revenue shared will be subject to a floor (e.g., $1000) to reflect that the overwhelming majority of individual lists will generate minimal revenue and so not be worth the effort of paying out the share to the originator. The share will also be subject to a upper limit cap (e.g., $100,000) because, at a certain dollar amount, the originator is sufficiently motivated. The percentage of share will graduate upward in favor of the originator as the list generates more revenue. Below is a sample of a revenue sharing schedule.

Sample Revenue Sharing Schedule

| Annual Revenue | Percentage of |
|---|---|
| Generated by List | Revenue for Originator |
| <$1000-$5000 | 10% |
| $5000-$25,000 | 25% |
| $25,000-$75,000 | 35% |
| $75,000-$100,000 | 45% |
| >$100,000 | 50% |

Revenue share to originators may be paid out monthly or quarterly. The Web site will also allow an originator to send his revenue share to certain selected charities or designate their own. Involvement of charities in this way may motivate list interest and participation (e.g., top ten most spectacular national parks list originator donates his revenue share to the Sierra Club).

There are also other revenue streams that could be driven from the Web site database. Upon crossing some threshold of list participant volume, the consumer data mining opportunity may become significant. Frequent list participants may end up revealing valuable information about their interests and preferences—this information may have great value to sellers of products related to those interests. Similarly, the e-mail addresses of list participants may generate material income.

Some specific aspects of the invention include:

1. List making tool: Tool that allows user to (a) define and name a list and list topic, (b) populate the list with items, (c) link the user's commentary to individual items, (d) then drag and drop or otherwise reorder the items so as to create the desired ranking or order among list items, and (e) finally, upload the list to a central database where all of the data associated with the list is stored. See home page on site flow chart.

2. Media loading tool to augment list: Tool that allows a user to upload media (images, audio, or video) to a central database and associate that media with specific items in lists. See home page on site flow chart.

3. Media playing function imbedded in lists: Tool that allows a user to press a “button” associated with an item on a list that triggers the playing of media (images, audio, or video) associated with that list item. The playing of the media may either be by means of downloading or streaming media from the Web site's own storage devices or by means of linking to a third party's devices (e.g., YouTube). Another “button” would enable the user to play all media items associated with a list sequentially (e.g., audio playlists could be played by pressing a single “button”). See search list titles results page.

4. Search lists by title, contributors, originator, or groups: Tool that allows user to search a database of lists by the title of the lists or by the list's originator, contributors, category, or the group the list was created for or by items on the list. Tool then displays lists responsive to the user's query organized by the type of search (i.e., for searches by group, only groups are displayed in response). See home page. Also, a tool that even absent a user's search allows the system to identify and display in a single location or Web page, all of the lists of a particular list originator or group. See groups page and originator page.

5. Display lists by selecting category of lists: Tool that organizes a large number of lists into categories and allows the user to click on a category name and then have only lists belonging to that category displayed.

6. Distribute Lists: Tool that enables a user to efficiently share a list they created with one or more other individuals via e-mail with list related content or imbedded links to Web pages populated by list related content from the database, or both. See share list page. Related tool that allows a recipient of a list to in turn share that list with other third parties. See invitee page.

7. List Modification: Tool that enables the recipient of a list to manipulate the list in the following ways to create a new list: (a) drag and drop or otherwise reorder some or all of the original lists items (and associated comments and media) into the same or different “slots” in the new list, (b) add new items, comments, or media to the new list, (c) drag and drop or otherwise reorder the original list items and the new items until the desired ranking or order is obtained. Then user can upload the new list to the centralized database for inclusion in an aggregated list by participants. See invitee page.

8. Display Lists in Other Online Venues: Tool that allows user to easily display lists and their associated comments and media within Web pages, blogs, and other locations.

9. Aggregated List Generation: Tool that enables the aggregation of multiple lists related by the same topic or definition into a single list representing the aggregate preferred ranking reflected in each list. Put another way, a tool for combining the individual preferences of a large group for a particular topic, category, or list into a single list representing the aggregated preference of the entire group. This is different than other list sites out there because they maintain a single list for topics and do not allow the user to create a new list that includes only the input of recipients designated by the user.

There will be multiple ways to accomplish this. One the method is to assign a point value to each list item based on the place it appears on the list. For example, for the aggregation of lists each of which have ten items, ten points would be assigned to each item appearing first on one of the lists, nine points to each item appearing second, and so on. The aggregated list would display the item receiving the most overall points in the first position.

10. List Ranking Method—“Round Robin”: Tool that enables the user to efficiently rank order a list by asking user their preference between two items at a time and then aggregating the responses into a ranking of all items. For example, for a list of three items, A, B, and C, user is asked if they prefer A to B, then B to C, and then A to C, and the tool automatically uses the user's responses to rank order A, B, and C.

List Ranking Method—Weighted Values: Tool that enables the user to rank order a list by: (a) naming criteria by which the order will be achieved, (b) relative weightings between the criteria, and (c) orchestrating users' evaluation of each list item against these weighted criteria.

12. Nominees: A tool that allows a user to populate a field of “nominees” for inclusion in a list. This augments the creation of the list for the user and any third party recipient to the list by virtue of presenting additional candidates for the list. Nominees can be text, images, audio, or video. Nominees will also be generated in automated fashion from list items submitted by other list participants and by an automated search of the Internet for list related items.

13. Password Protecting Lists: Tool that enables users to password protect lists that are distributed to third parties.

14. List Timers: Tool that allows creators of lists to associate and display a timer with the list. When the timer counts down to zero, the list is “closed” and recipients of the list can no longer submit their own versions of the list for inclusion in an aggregated list.

15. Data Mining by List Activity: Tool that enables the drawing of conclusions about an individual's interests, needs, views, and preferences based on the individual's participation in the creation of one or more lists. In an implementation, the system will be able identify the members of groups based upon their participation in group lists.

16. List Certification: The system will display certain lists as certified that it will have done some level of verification around. Verification may include confirming the identity of list contributors or originator or group. It may also include confirming the truth of certain factual statements on the list.

17. A software tool that, in an automated fashion, searches all Internet pages for all varieties of lists and imports them into a centralized database along with the all of the data related to the Web site (e.g., what site it was found on, list author, title, and so forth).

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

The invention claimed is:

1. A method comprising:
receiving a first list of items from a first user, wherein the first list comprises at least a first item;
receiving a second list of items from a second user, wherein the second list comprises the at least first item;
determining an order for a third list of items wherein the third list includes the at least first item and the determination includes performing a mathematical computation involving a first value and a second value, the first value corresponding to a first position of the first item in the first list and the second value corresponding to a second position of the first item in the second list; and
displaying on a computer screen the third list of items in the order.

2. The method of claim 1 wherein the first list and second list further comprise at least a second item.

3. The method of claim 2 wherein the mathematical computation further involves a third value and a fourth value, the third value corresponding to a third position of the second item in the first list and the fourth value corresponding to a fourth position of the second item in the second list.

4. The method of claim 3 wherein when displaying on a computer screen the third list of items in the order, if the first value added to the second value is greater than the third value added to the fourth value, displaying the first item above the second item.

5. The method of claim 3 wherein when displaying the third list of items on a computer screen in the order, if the first value added to the second value is less than the third value added to the fourth value, displaying the first item below the second item.

6. The method of claim 1 further comprising:
displaying on the computer screen a user-selectable object associated with the first list; and
when the second user selects the user-selectable object, displaying on the computer screen for the second user the first list of items from the first user.

7. The method of claim 6 wherein the user-selectable object is a hyperlink comprising a username of the first user.

8. The method of claim 1 wherein the at least first item comprises a multimedia file stored on a central server.

9. A method comprising:
displaying a first plurality of items from a list in a main item section on an electronic screen, wherein an item comprises a first user-selectable button, a number, and an item name;
displaying a second plurality of items from the list in an item scroll box having a scroll bar;
when a first user selects the first user-selectable button using a pointing device, displaying an edit item window, wherein the edit item window comprises an item title input box; and
as a user drags the scroll bar, displaying additional items from the list in the item scroll box without closing the edit item window.

10. The method of claim 9 wherein the first plurality of items from the list comprises a subset of items from the list and the item scroll box comprises a complete set of items from the list.

11. The method of claim 9 wherein when the first user selects a first item name from the item scroll box using the pointing device, displaying the first item name in the item title input box of the edit item window.

12. The method of claim 11 wherein the edit item window comprises a second user-selectable button, and when the first user selects the second user-selectable button, closing the edit item window and displaying the first item name from the item scroll box in the main item section.

13. The method of claim 9 wherein the edit item window further comprises an item universal resource locator input box.

14. The method of claim 9 wherein the item name is a hyperlink.

15. The method of claim 9 wherein the first plurality of items is an ordered list.

16. The method of claim 15 wherein the ordered list comprises a first item, a second item, and a third item, the first item is displayed above the second item and the third item, and the second item is displayed above the third item, and when the user drags the first item to a position between the second item and the third item,
displaying the second item above the first item and the third item, and the first item above the third item.

17. The method of claim 12 further comprising the step of receiving a command from the first user to save the list after displaying the first item name from the item scroll box in the main item section; and
after receiving the command, sending a notification to a second user.

18. The method of claim 17 wherein the notification comprises an e-mail having a link to the list.

19. The method of claim 9 further comprising displaying an item title wherein the item title is noneditable by the first user.

20. The method of claim 14 wherein after the first user clicks on the hyperlink, playing a multimedia file on a first user's client device, wherein the multimedia file is stored on a centrally located server.

21. The method of claim 17 wherein the notification is via an RSS feed.
